(19) United States
(12) Patent Application Publication
(10) Pub. No.: US 2007/0119476 A1
(43) Pub. Date: May 31, 2007

(54) SUBSTRATE PROCESSING APPARATUS AND SUBSTRATE PROCESSING METHOD

(76) Inventors: Takashi Hara, Kamigyo-ku (JP); Koichi Mukaegaki, Kamigyo-ku (JP)

Correspondence Address: OSTROLENK FABER GERB & SOFFEN, 1180 AVENUE OF THE AMERICAS, NEW YORK, NY, 100368403, US

(21) Appl. No.: 11/562,773

(22) Filed: Nov. 22, 2006

(30) Foreign Application Priority Data
Nov. 25, 2005 (JP) 2005-341094

(51) Int. Cl. B08B 6/00

(52) U.S. Cl. 134/1.3; 134/33

(57) ABSTRACT

A substrate held by a spin chuck is supplied with a chemical solution by a chemical solution nozzle and a processing of the substrate is performed. At this time, the chemical solution supplied to the substrate scatters around and adheres to members (processing cup and splash guard) residing near the substrate. In the process of the substrate, a first cleaning liquid having the same ingredients as those of the chemical solution is supplied to an outer wall face of the splash guard from the guard cleaning nozzles without being in contact with the substrate. Thus, the outer wall face of the splash guard and the inner wall face of the processing cup are cleaned by the clean first cleaning liquid. The chemical solution supplied to the substrate and the first cleaning liquid supplied to the outer wall face of the splash guard are reused.

### BACKGROUND OF THE INVENTION

1. Field of the Invention

The present invention relates to a substrate processing apparatus that performs a predetermined process on a substrate and a substrate processing method.

2. Description of the Background Art

Conventionally, in order to perform a variety of processes on a substrate such as a semiconductor wafer, glass substrate for a photomask, glass substrate for a liquid crystal display, glass substrate for an optical disc or the like, a substrate processing apparatus is used.

In a substrate processing apparatus, for example, by supplying a substrate with a chemical solution of BHF (buffered hydrofluoric acid), DHF (diluted hydrofluoric acid), hydrofluoric acid, hydrochloric acid, sulfuric acid, nitric acid, phosphoric acid, acetic acid, oxalic acid, ammonia or the like, or a mixture thereof, a surface process of the substrate (hereinafter, called“chemical solution process”) is performed.

As a substrate processing apparatus for performing a chemical solution process, a sheet-type substrate processing apparatus is disclosed in JP 2005-191144 A. In the following, description will be given for the structure and operation of a substrate processing apparatus shown in JP 2005-191144 A.

FIGS. 18 to 21 are views for explaining the structure and operation of a conventional substrate processing apparatus. FIG. 18 shows the structure of a cleaning processing unit provided in a substrate processing apparatus of JP 2005-191144 A.

As shown in FIG. 18, a cleaning processing unit 900 includes a spin chuck 921 for allowing rotation of a substrate W about a vertical rotation axis passing through the center of the substrate W while keeping the substrate W horizontal. The spin chuck 921 is secured to the upper end of a rotary shaft 925 rotated by a chuck rotation-driving mechanism (not shown).

Above the spin chuck 921, an oxidation processing nozzle 950 and an etching nozzle 970 are provided in a movable manner.

The oxidation processing nozzle 950 is supplied with ozone water. Thus, the ozone water can be supplied to the surface of the substrate W. The etching nozzle 970 is supplied with hydrogen fluoride water. Thus, the hydrogen fluoride water can be supplied to the surface of the substrate W.

When the ozone water is supplied to the surface of the substrate W, the oxidation processing nozzle 950 is situated above the substrate W, and when the hydrogen fluoride water is supplied to the surface of the substrate W, the oxidation processing nozzle 950 is retracted to a predetermined position.

When the ozone water is supplied to the surface of the substrate W, the etching nozzle 970 is retracted to a predetermined position, and when the hydrogen fluoride water is supplied to the surface of the substrate W, the etching nozzle 970 is positioned above the substrate W.

The spin chuck 921 is housed in a processing cup 923. Inside the processing cup 923, a cylindrical partition wall 933 is provided. Also, a drain space 931 provided for draining the ozone water used in the process of the substrate W is formed to surround the circumference of the spin chuck 921. Further, between the processing cup 923 and the partition wall 933, a solution recovery space 932 for recovering the hydrogen fluoride water used in the process of substrate W is formed to surround the drain space 931.

A drain pipe 934 is connected to the drain space 931 for leading the ozone water to a drain processing device (not shown), and a recovery pipe 935 is connected to the solution recovery space 932 for leading the hydrogen fluoride water to a recovery processing device (not shown).

Above the processing cup 923, a guard 924 is provided for preventing the ozone water or the hydrogen fluoride water from the substrate W from scattering outwardly. The guard 924 has a rotation symmetric shape with respect to the rotary shaft 925. In the inner face of the upper end of the guard 924, a drain guiding groove 941 having a generally V-shaped cross section is annularly formed.

Further, in the inner face of the lower end of the guard 924, a recovery liquid guiding part 942 formed of a slant face which is inclined outwardly and downwardly is provided. Near the upper end of the recovery liquid guiding part 942, a partition wall-housing groove 943 for receiving the partition wall 933 of the processing cup 923 is formed.

The guard 924 is supported so as to be movable up and down by a guard lifting mechanism (not shown) composed of a ball screw mechanism or the like.

The guard lifting mechanism moves up and down the guard 924 between a circulation position P2 in which the recovery liquid guiding part 942 is opposite to the outer circumference of the substrate W held by the spin chuck 921 and a drain position P3 in which the drain guiding groove 941 is opposite to the outer circumference of the substrate W held by the spin chuck 921.

When the upper end of the guard 924 is in the circulation position P2, as shown in FIG. 19, the hydrogen fluoride water scattering outward from the substrate W is led to the solution recovery space 932 by the recovery liquid guiding part 942 and recovered through the recovery pipe 935. On the other hand, when the upper end of the guard 924 is in the drain position P3, as shown in FIG. 20, the ozone water scattering outward from the substrate W is led to the drain space 931 by the drain guiding groove 941, and drained out through the drain pipe 934. With the above structure, the drainage of the ozone water and the recovery of the hydrogen fluoride water are achieved.

In the above substrate processing apparatus, the guard lifting mechanism moves the guard 924 so that the upper end of the guard 924 is in a position lower than the level of the substrate W held by the spin chuck 921 (carrying in and out position P1) when the substrate W is carried in or carried out to/from the cleaning processing unit 900, as shown in FIG. 21. In this state, the substrate W is carried onto the spin chuck 921, or the substrata W is carried out from the spin chuck 921.

The cleaning processing unit 900 having the structure as described above, however, has the following problem. The problem will be described with reference to FIG. 22.

FIG. 22 is a view for explaining the problem associated with the conventional cleaning processing unit 900.

As described above, in the chemical solution process, the upper end of the guard 924 is moved to the circulation position P2 in order to recover the chemical solution used in the process. In this case, the chemical solution scattering from the substrate W is received by the recovery liquid guiding part 942 of the guard 924 and flows down under guidance of the shape thereof.

Then the chemical solution having flown to the lower end of the guard 924 further flows down along the inner wall face of the processing cup 923 and is led to the recovery pipe 935.

In the chemical solution process, a chemical solution containing a salt such as BHF which is a mixture solution of ammonium fluoride and hydrogen fluoride, and a mixture solution containing ammonium fluoride and phosphoric acid may be used as well as the aforementioned hydrogen fluoride water.

If the chemical solution containing a salt remains on the guard 924 and on the inner wall face of the processing cup 923, or the atmosphere of the chemical solution containing a salt remains in the solution recovery space 932, the chemical solution is gradually dried with the time, so that the salt contained in the chemical solution precipitates, and the precipitates (deposits J) adhere to members (peripheral members) provided in the periphery of the spin chuck 921.

In this manner, the deposits J on the members (peripheral members) provided around the spin chuck 921 may be stripped off during the operation of the cleaning processing unit 900.

Further, the deposits J of the chemical solution also adhere to the outer wall face of the guard 924 with which the chemical solution does not actually come into direct contact. When the guard 924 moves up or down in the presence of the deposits J on the outer wall face of the guard 924, the deposits J may be stripped off the outer wall face.

When the deposits J on the peripheral members of the spin chuck 921 are stripped off as described above, the stripped deposits J may scatter in the form of particles, and adhere to the substrate W during the process or carrying. As a result, processing defects occur on the substrate W.

Therefore, in order to sufficiently prevent the processing defects in the substrate W, it is necessary to clean the peripheral members of the spin chuck 921. For achieving this, conventionally, the peripheral members of the spin chuck 921 are cleaned while the operation of the substrate processing apparatus is stopped.

Stopping the operation of the substrate processing apparatus to clean the peripheral members of the spin chuck 921 will deteriorate the throughput of the substrate processing.

### SUMMARY OF THE INVENTION

It is an object of the present invention to provide a substrate processing apparatus and a substrate processing method capable of sufficiently preventing processing defects of the substrate caused by adhesion of a chemical solution to members without reducing the throughput.

(1) A substrate processing apparatus according to one aspect of the present invention includes a substrate holding device that folds a substrate, a chemical solution supplying device that supplies the substrate held by the substrate holding device with a chemical solution, a member provided in the position where the chemical solution scattering from the substrate held by the substrate holding device adheres, a cleaning liquid supplying device that cleans the member by supplying the member with a cleaning liquid having the same ingredients as the chemical solution without being in contact with the substrate held by the substrate holding device, and a recovering device that recovers the chemical solution supplied by the chemical solution supplying device and the cleaning liquid supplied to the member by the cleaning liquid supplying device.

In this substrate processing apparatus, the substrate held by the substrate holding device is supplied with the chemical solution by the chemical solution supplying device for processing of the substrate. At this time the chemical solution supplied to the substrate scatters peripherally and adheres to the member.

The cleaning liquid having the same ingredients as the chemical solution is supplied by the cleaning liquid supplying device to the member to which the chemical solution adheres without being in contact with the substrate. In this way, the member is cleaned with the clean cleaning liquid.

Since the member is cleaned with the cleaning liquid having the same ingredients as the chemical solution, it is possible to clean the member at the time of processing the substrate, or at the time of supplying the substrate held by the substrate holding device with the chemical solution. Therefore, it is possible to clean the member efficiently without reducing the throughput of the substrate processing.

Even when the chemical solution remains on the member, by supplying the cleaning liquid having the same ingredients to the chemical solution that remains, it is possible to prevent the chemical solution from being dried. Thus, generation of precipitates from the chemical solution is prevented, and generation of particles from the precipitates of the chemical solution can be prevented.

Furthermore, when the precipitates from the chemical solution adhere to the member, the precipitates can be readily dissolved and washed out by the cleaning liquid having the same ingredients as the chemical solution. Thus, generation of particles from the precipitates of the chemical solution is prevented.

In this manner, processing defects on the substrate is sufficiently prevented by preventing generation of particles from the precipitates of the chemical solution.

Further, the chemical solution supplied to the substrate and the cleaning liquid supplied to the member are recovered by a recovering device. As a result, the recovered chemical solution and cleaning liquid can be reused. This reduces the production cost of the substrate.

(2) The concentration of the cleaning liquid supplied to the member by the cleaning liquid supplying device may be substantially equal to that of the chemical solution supplied to the substrate by the chemical solution supplying device.

In this case, the chemical solution and the cleaning liquid recovered by the recovering device can be reused easily for processing of the substrate without readjustment of concentrations thereof. Thus, the structure of the recovering device can be simplified, and the production cost of substrate can be sufficiently reduced.

(3) The cleaning liquid supplying device may supply the member with a cleaning liquid in which a gas is mixed. In this case, the bubbles compressed by the internal pressure of the cleaning liquid supplying device are expanded as they are supplied to the member from the cleaning liquid supplying device. Thus, the cleaning liquid is injected at a large spread angle from the cleaning liquid supplying device. Thus, a wide range of the member can be cleaned.

(4) The substrate processing apparatus may further includes a controller that controls supply of the cleaning liquid to the member, and the controller may control the cleaning liquid supplying device so that the cleaning liquid is supplied to the member while the chemical solution is supplied to the substrate by the chemical solution supplying device.

In this case, while the chemical solution is supplied to the substrate, the controller controls the cleaning liquid supplying device to supply the member with the cleaning liquid. Thus, the chemical solution adhering to the member is prevented from remaining and being dried. In addition, generation of precipitates from the chemical solution adhering to the member is prevented. As a result, generation of particles from the precipitates of the chemical solution is prevented.

Further, since the member is cleaned during processing of the substrate, reduction in throughput of the substrate processing is securely avoided.

(5) The substrate processing apparatus may further includes a controller that controls supply of the cleaning liquid to the member, and the controller may control the cleaning liquid supplying device to intermittently supply the member with the cleaning liquid.

In this case, since the cleaning liquid having the same ingredients as the chemical solution is intermittently supplied to the member to which the chemical solution adheres, it is possible to prevent the chemical solution adhering to the member from remaining and being dried. Further, generation of precipitates from the chemical solution adhering to the member is prevented. As a result, generation of particles from the precipitates of the chemical solution is prevented.

(6) The substrate processing apparatus may further includes a controller that controls supply of the cleaning liquid, and a detector that provides the controller with a detection signal indicating change in surface condition in a part of the member where the chemical solution scattering from the substrate held by the substrate holding device adheres, and the controller may control the cleaning liquid supplying device to supply the member with the cleaning liquid based on the detection signal provided by the detector.

In this case, change in surface condition in a part of the member where the chemical solution adheres is provided by the detector as a detection signal to the controller. Based on the detection signal, the controller controls the cleaning liquid supplying device to supply the member with the cleaning liquid. Thus, the member can be cleaned when precipitates of the chemical solution adhere to the member, so that wasteful consumption of the cleaning liquid can be prevented.

(7) The substrate processing apparatus may further include a dissolving liquid supplying device that supplies a part of the member and the cleaning liquid supplying device where the cleaning liquid supplied from the cleaning liquid supplying device adheres, with a dissolving liquid having different ingredients from the cleaning liquid supplied to the member by the cleaning liquid supplying device and capable of dissolving the cleaning liquid.

In this case, a part of the member and the cleaning liquid supplying device where the cleaning liquid supplied from the cleaning liquid supplying device adheres is supplied with a dissolving liquid having different ingredients. Thus, when the cleaning liquid remains on the member and on the cleaning liquid supplying device, the cleaning liquid can be dissolved by the dissolving liquid. As a result, the cleaning liquid remaining in the member is prevented from being dried, and generation of the precipitates from the cleaning liquid remaining on the member is prevented. As a result, generation of particles from the precipitates of the cleaning liquid is prevented, and processing defects of substrate is prevented.

(8) The cleaning liquid supplying device may have a discharge opening through which the cleaning liquid is discharged, and the dissolving liquid supplying device may supply the discharge opening of the cleaning liquid supplying device with the dissolving liquid.

In this case, the cleaning liquid is discharged through the discharge opening of the cleaning liquid supplying device. By the dissolving liquid supplying device, the dissolving liquid is supplied to the discharge opening of the cleaning liquid supplying device. Thus, the cleaning liquid adhering in the vicinity of the discharge opening of the cleaning liquid supplying device is washed out by the dissolving liquid. Thus, generation of particles from the precipitates of the cleaning liquid is prevented, and processing defects of substrate is prevented.

(9) The substrate processing apparatus may further include a rinse liquid supplying device that supplies the substrate held by the substrate holding device with a rinse liquid for washing out the chemical solution remaining on the substrate, and the dissolving liquid supplying device may supply the member and the cleaning liquid supplying device with the dissolving liquid at the time of supplying the rinse liquid.

In this case, the rinse liquid is supplied to the substrate by the rinse liquid supplying device. When the rinse liquid is supplied to the substrate, the dissolving liquid is supplied to the member and the cleaning liquid supplying device by the dissolving liquid supplying device.

Thus, it is possible to wash out the cleaning liquid remaining in the member and the cleaning liquid supplying device at the time of processing by the rinse liquid, so that reduction in throughput of substrate processing is securely prevented.

(10) The substrate processing apparatus may further include a rotation driving device that rotates the substrate holding device for drying the substrate, and the dissolving liquid supplying device may supply the dissolving liquid to the member and the cleaning liquid supplying device at the time of drying the substrate.

In this case, the substrate holding device is rotated by the rotation driving device. In this manner, the substrate held by the substrate holding device can be dried. At the time of drying the substrate, the dissolving liquid is supplied to the member and the cleaning liquid supplying device by the dissolving liquid supplying device.

Thus, it is possible to wash out the cleaning liquid remaining in the member and the cleaning liquid supplying device at the time of drying the substrate, and reduction in throughput of substrate processing is securely prevented.

(11) The substrate processing apparatus may further include a circulation system that returns the chemical solution recovered by the recovering device to the chemical solution supplying device, and the member may include a guiding member that leads the chemical solution supplied to the substrate by the chemical solution supplying device and the cleaning liquid supplied to the member by the cleaning liquid supplying device to the recovering device.

In this case, the chemical solution supplied to the substrate by the chemical solution supplying device and the cleaning liquid supplied to the member by the cleaning liquid supplying device are led to the recovering device by the guiding member. The chemical solution recovered by the recovery member is returned to the chemical solution supplying device by the circulation system. The chemical solution recovered by the recovery member can further be supplied to the substrate from the chemical solution supplying device.

In this manner, by reusing the chemical solution supplied to the substrate by the chemical solution supplying device and the cleaning liquid supplied to the member by the cleaning liquid supplying device for processing of a substrate, it is possible to sufficiently reduce the production cost of the substrate.

When the cleaning liquid is led to the recovery member by the guiding member, the guiding member is also cleaned by the cleaning liquid. Therefore, at the time of substrate processing, it is possible to clean the guiding member without deteriorating the throughput in substrate processing.

(12) The guiding member may include an anti-scattering member that is provided so as to surround the substrate holding device and receives a chemical solution scattering from the substrate held by the substrate holding device.

In this case, the chemical solution scattering from the substrate held by the substrate holding device is received by the anti-scattering member provided so as to surround the substrate holding device and led to the recovering device. Thus, the chemical solution scattering from the substrate is prevented from scattering still outwardly. Therefore, it is possible to securely lead the chemical solution scattering from the substrate to the recovering device.

When the cleaning liquid is led to the recovery member by the anti-scattering member of the guiding member, the anti-scattering member is also cleaned by the cleaning liquid. Therefore, it is possible to clean the anti-scattering member at the time of substrate processing without reducing the throughput of the substrate processing.

(13) The guiding member may further include a receiving member that is provided below the anti-scattering member and receives the chemical solution flowing down from the anti-scattering member and leads the chemical solution to the recovering device.

In this case, the chemical solution flowing down from the anti-scattering member is received by the receiving member and led to the recovering device. Thus, the chemical solution received by the anti-scattering member can be securely led to the recovering device.

When the cleaning liquid is led to the recovery member by the receiving member of the guiding member, the receiving member is also cleaned with the cleaning liquid. Therefore, it is possible to clean the receiving member at the time of substrate processing without reducing the throughput of the substrate processing.

(14) The cleaning liquid supplying device may include a cylindorical member provided along an inner wall face of the guiding member and having a plurality of cleaning liquid supply openings opposite to the inner wall face of the guiding member.

In this case, the cleaning liquid is supplied to the inner wall face of the guiding member through the plurality of the cleaning liquid supply openings. Thus, the inner wall face of the guiding member can be widely cleaned by the cylindorical member having a simple structure.

(15) The chemical solution may be a removing liquid that removes contaminants on the surface of the substrate. In this case, contaminants on the surface of the substrate are removed by the chemical solution supplied to the substrate. Thus, it is possible to clean the surface of the substrate.

By cleaning the member with the cleaning liquid having the same ingredients as the chemical solution, it is possible to remove the contaminants together with the chemical solution that adheres to the member.

(16) The chemical solution may be a solution containing a salt. Precipitates of salt are likely to occur as a result of drying of such a chemical solution. Therefore, by cleaning the member with the cleaning liquid having the same ingredients as the chemical solution, it is possible to dissolve and remove the precipitates of the chemical solution that adheres to the member.

(17) A substrate processing method according to another aspect of the present invention includes the steps of processing a substrate by supplying a substrate held by the substrate holding device with a chemical solution, cleaning the member by supplying a member provided in a position where the chemical solution scattering from the substrate adheres, with a cleaning liquid having the same ingredients as the chemical solution without being in contact with the substrate held by the substrate holding device, and recovering the chemical solution supplied to the substrate and the cleaning liquid supplied to the member.

In this substrate processing method, a substrate is processed while the chemical solution is supplied to the substrate held by the substrate holding device. At this time, the chemical solution supplied to the substrate scatters circumferentially and adheres to the member.

The cleaning liquid having the same ingredients as the chemical solution is supplied to the member to which the chemical solution adheres without being in contact with the substrate. Thus, the member is cleaned with a clean cleaning liquid.

Since the member is cleaned with the cleaning liquid having the same ingredients as the chemical solution, the member can be cleaned during the processing of the substrate, or during supply of the chemical solution to the substrate held by the substrate holding device. Thus, it is possible to clean the member efficiently without deteriorating the throughput of the substrate processing.

Even when the chemical solution remains on the member, by supplying the cleaning liquid having the same ingredients with the chemical solution that remains, the chemical solution is prevented from being dried. Thus, generation of particles from the dried matter of the chemical solution is prevented.

Furthermore, when precipitates of the chemical solution adhere to the member, the precipitates can be easily dissolved and washed out by the cleaning liquid having the same ingredients as the chemical solution. Thus, generation of particles from the precipitates of the chemical solution is prevented.

In this way, generation of particles from the precipitates of the chemical solution is prevented, so that the processing defects on the substrate is sufficiently prevented.

Further, the chemical solution supplied to the substrate and the cleaning liquid supplied to the member are recovered. Thus, the recovered chemical solution and cleaning liquid may be reused. As a result, the production cost for the substrate is reduced.

(18) The step of cleaning the member may further include a step of supplying a member with a cleaning liquid while the chemical solution is supplied to the substrate.

In this case, the cleaning liquid is supplied to the member while the chemical solution is supplied to the substrate. Thus, the chemical solution adhering to the member is prevented from remaining and being dried. Further, generation of the precipitates from the chemical solution adhering to the member is prevented. As a result, generation of particles from the precipitates of the chemical solution is prevented.

Further, since the member is cleaned during the substrate processing, reduction in throughput of the substrate processing is securely prevented.

(19) The step of cleaning the member may include a step of intermittently supplying the cleaning liquid to the member. In this case, since the member to which the chemical solution adheres is intermittently supplied with the cleaning liquid having the same ingredients as the chemical solution, the chemical solution adhering to the member is prevented from remaining and being dried. Further, precipitation of the chemical solution adhering to the member is prevented. As a result, generation of particles from the precipitates of the chemical solution is prevented.

(20) The step of cleaning the member may include the steps of detecting change in surface condition of a part of the member where the chemical solution scattering from the substrate adheres, and controlling supply of the cleaning liquid to the member based on the detection of change in surface condition.

In this case, change in surface condition of a part of the member where the chemical solution adheres is detected, and supply of the cleaning liquid to the member is controlled based on the detection. Thus, wasteful consumption of the cleaning liquid is prevented because the member can be cleaned when the precipitates of the chemical solution adhere to the member.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a plan view of a substrate processing apparatus according to a first embodiment;

FIG. 2 is a view for explaining the structure of a cleaning processing unit in the substrate processing apparatus according to the first embodiment;

FIG. 3 is a view for explaining the structure of a guard cleaning nozzle of FIG. 2;

FIG. 4 is a view for explaining attachment of the guard cleaning nozzles in FIG. 2 to a processing cup;

FIG. 5 is an enlarged sectional view showing the state in which the guard cleaning nozzle is attached to the upper end of the processing cup;

FIG. 6 is a view showing a plurality of examples of timing of cleaning of a splash guard;

FIG. 7 is a view for explaining timing of cleaning when a deposit detector is used;

FIG. 8 is a view showing a cleaning process of the splash guard;

FIG. 9 is a view for explaining the effects of mixing a gas into the first cleaning liquid to be injected from the guard cleaning nozzle;

FIG. 10 is a system diagram of piping in the substrate processing apparatus of FIG. 1;

FIG. 11 is a view for explaining nozzle cleaning nozzles provided for cleaning the guard cleaning nozzles of FIG. 2;

FIG. 12 is a view for explaining a nozzle cleaning nozzle provided for cleaning a guard cleaning nozzle of FIG. 2;

FIG. 13 is a view showing a plurality of examples of timing of cleaning of the guard cleaning nozzles;

FIG. 14 is a view for explaining the structure of a cleaning processing unit in a substrate processing apparatus according to a second embodiment;

FIG. 15 is a partial enlarged sectional view of the cleaning processing unit shown in FIG. 14;

FIG. 16 is a view for explaining the structure of a cleaning processing unit in a substrate processing apparatus according to a third embodiment;

FIG. 17 is a partial enlarged sectional view of the cleaning processing unit shown in FIG. 14;

FIG. 18 is a view for explaining the structure and operation of a conventional substrate processing apparatus;

FIG. 19 is a view for explaining the structure and operation of a conventional substrate processing apparatus;

FIG. 20 is a view for explaining the structure and operation of a conventional substrate processing apparatus;

FIG. 21 is a view for explaining the structure and operation of a conventional substrate processing apparatus; and

FIG. 22 is a view for explaining a problem in a conventional cleaning processing unit.

### DESCRIPTION OF THE PREFERRED EMBODIMENTS

In the following, a substrate processing method and a substrate processing apparatus according to one embodiment of the present invention will be explained with reference to drawings.

In the following description, examples of a substrate include a semiconductor wafer, glass substrate for a liquid crystal display, glass substrate for a PDP (plasma display panel), glass substrate for a photomask, substrate for an optical disc, and the like.

Examples of a chemical solution include BHF (buffered hydrofluoric acid), DHF (diluted hydrofluoric acid), hydrofluoric acid, hydrochloric acid, sulfuric acid, nitric acid, phosphoric acid, acetic acid, oxalic acid, or an aqueous solution of ammonia or the like, as well as mixture solutions thereof.

Examples of a rinse liquid include pure water, carbonated water, ozone water, magnetic water, reduced water (hydrogen water) and ion water, as well as organic solvents such as IPA (isopropyl alcohol).

### 1. First Embodiment

(1) Structure of Substrate Processing Apparatus

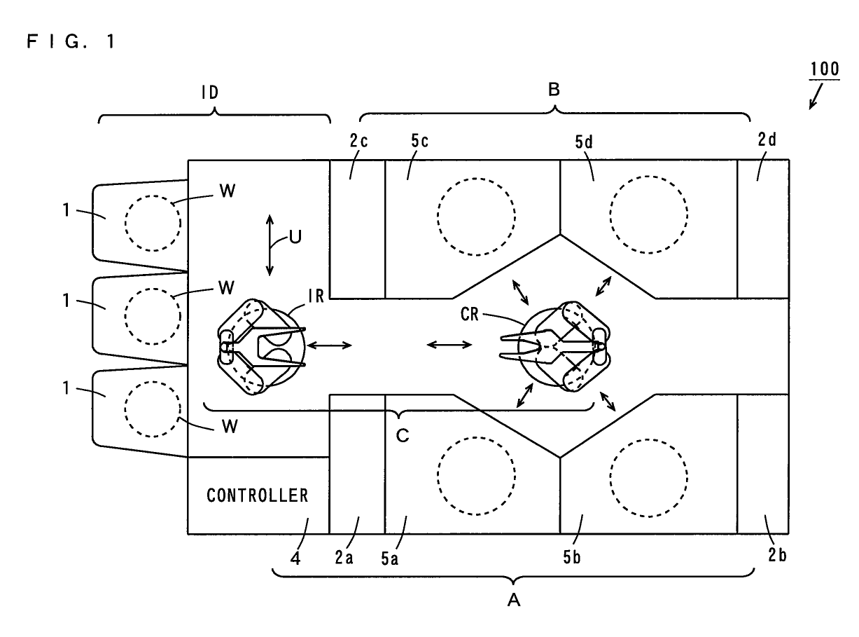

FIG. 1 is a plan view of a substrate processing apparatus according to a first embodiment. As shown in FIG. 1, the substrate processing apparatus 100 has processing regions A, B, and a transporting region C between the regions A, B.

The processing region A includes a controller 4, fluid boxes 2a, 2b, and cleaning processing units 5a, 5b.

The fluid boxes 2a, 2b shown in FIG. 1 respectively house fluid related equipment such as pipes, joints, valves, flow meters, regulators, pumps, temperature controllers and process solution storage tanks involved in supply of the chemical solution or drain (discharge) of the rinse liquid to/from the cleaning processing units 5a, 5b.

Each of the cleaning processing units 5a, 5b performs a cleaning process using a chemical solution (hereinafter, referred to as chemical solution process) and a cleaning process using a rinse liquid (hereinafter, referred to as a rinsing process). In the present embodiment, the chemical solution used in the cleaning processing units 5a-5b is, for example, BHF which is a mixture solution of ammonium fluoride and hydrogen fluoride, and the rinse liquid is pure water.

In the processing region B, fluid boxes 2c, 2d and cleaning processing units 5c, 5d are provided. Each of the fluid boxes 2c, 2d and the cleaning processing units 5c, 5d has a similar structure to that of the fluid boxes 2a, 2b and the cleaning processing units 5a, 5b as described above, and the cleaning processing units 5c, 5d perform the same process as the cleaning processing units 5a, 5b.

Hereinafter, the cleaning processing units 5a, 5b, 5c, 5d will be collectively referred to as processing units. The transporting region C includes a substrate transporting robot CR.

On one end of the processing region A, B, an indexer ID for carrying in and out a substrate is provided. Inside the indexer ID an indexer robot IR is provided. On the indexer ID, carriers 1 for accommodating substrates W are placed.

The indexer robot IR of the indexer ID moves in the direction of an arrow U to take out a substrate W from a carrier 1, and transfers the substrate W to the substrate transporting robot CR. Conversely, the indexer robot IR receives a substrate W subjected to a series of processes from the substrate transporting robot CR, and returns it to a carrier 1.

The substrate transporting robot CR transports the substrate W transferred from the indexer robot IR to a specified processing unit, or transports the substrate W received from the processing unit to another processing unit or to the indexer robot IR.

In the present embodiment, after a chemical solution process or a rinsing process is performed on the substrate W in any one of the cleaning processing units 5a-5d, the substrate W is carried out from the cleaning processing unit 5a-5d by the substrate transporting robot CR and carried into a carrier 1 via the indexer robot IR.

The controller 4 is composed of a computer having a CPU (central processing unit) and or like, and controls operations of the respective processing units in the processing regions A, B, operations of the substrate transporting robot CR in the transporting region C, and operations of the indexer robot IR of the indexer ID.

(2) Structure of cleaning Processing Unit

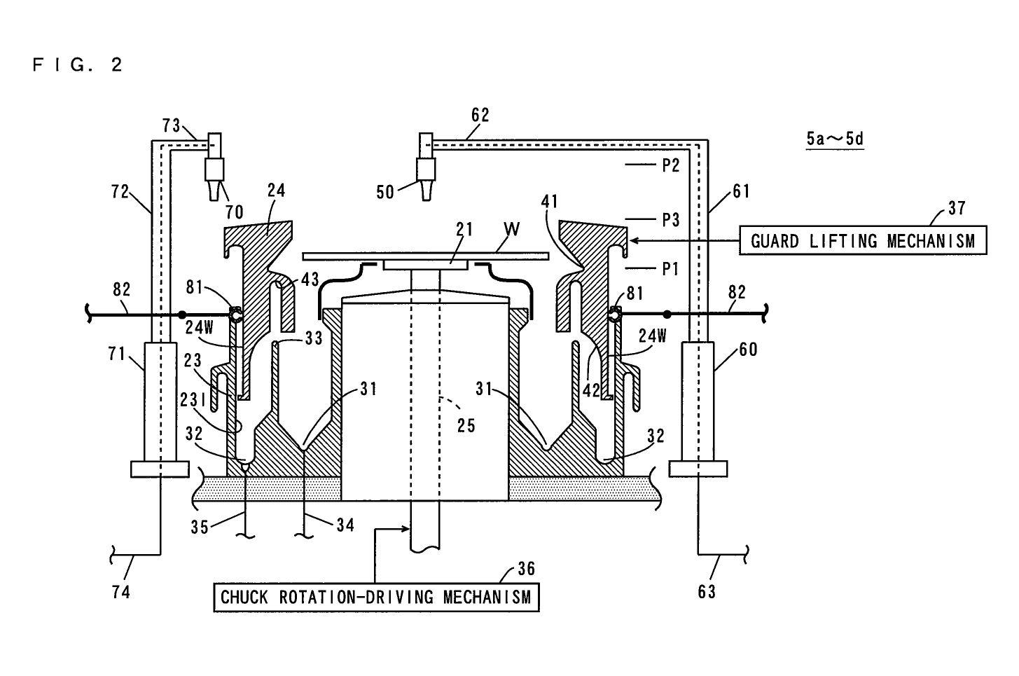

FIG. 2 is a view for explaining the structure of a cleaning processing unit 5a-5d in the substrate processing apparatus 100 according to the first embodiment.

The cleaning processing unit 5a-5d in FIG. 2 performs a rinsing process after removing impurities such as organic substances that adhere to the surface of the substrate W by a chemical solution process.

As shown in FIG. 2, the cleaning processing unit 5a-5d includes a spin chuck 21 for allowing rotation of the substrate W about a vertical rotation axis passing through the center of the substrate W while keeping the substrate W horizontal. The spin chuck 21 is secured to the upper end of a rotary shaft 25 rotated by a chuck rotation-driving mechanism 36.

The substrate W is rotated while being held horizontally by the spin chuck 21 during a chemical solution process and a rinsing process. As shown in FIG. 2, in the present embodiment, the spin chuck 21 is composed of a suction spin chuck, however, a spin chuck which holds the periphery of the substrate W may be employed.

A motor 60 is provided external to the spin chuck 21. The motor 60 is connected with a rotation shaft 61. The rotation shaft 61 is coupled to an arm 62 extending in the horizontal direction, of which end is provided with a chemical solution nozzle 50.

The motor 60 allows the rotation shaft 61 to rotate and the arm 62 to swing, and thus the chemical solution nozzle 50 moves above the substrate W held by the spin chuck 21.

A supply pipe 63 for chemical solution process is provided so as to pass through the inside of the motor 60, the rotation shaft 61 and the arm 62. The supply pipe 63 for chemical solution process is connected with the fluid box 2a-2d.

The chemical solution nozzle 50 of the cleaning processing unit 5a-5d is supplied with a chemical solution (BHF) from the fluid box 2a-2d via the supply pipe 63 for chemical solution process. Thus, the chemical solution can be supplied to the surface of the substrate W.

The chemical solution is supplied to the surface of the substrate W when the chemical solution nozzle 50 is situated above the substrate W, whereas the chemical solution is not supplied to the surface of the substrate W when the chemical solution nozzle 50 is retracted to a predetermined position.

Also, a motor 71 is provided external to the spin chuck 21. The motor 71 is connected with a rotation shaft 72. The rotation shaft 72 is coupled with an arm extending in the horizontal direction, of which end is provided with a rinsing nozzle 50.

The motor 71 allows the rotation shaft 72 to rotate and the arm 73 to swing, and thus the rinsing nozzle 50 moves above the substrate W held by the spin chuck 21.

A supply pipe 74 for rinsing process is provided so as to pass through the inside of the motor 71, the rotation shaft 72 and the arm 73. The supply pipe 74 for rinsing process is connected with fluid box 2a-2d.

The rinsing nozzle 50 of the cleaning processing unit 5a-5d is supplied with a rinse liquid (pure water) from the fluid box 2a-2d via the supply pipe 74 for rinsing process. Thus, the rinse liquid can be supplied to the surface of the substrate W.

The rinse liquid is supplied to the surface of the substrate W when the rinsing nozzle 50 is situated above the substrate W, whereas the rinse liquid is not supplied to the surface of the substrate W when the rinsing nozzle 50 is retracted to a predetermined position.

The spin chuck 21 is housed in the processing cup 23. Inside the processing cup 23 is provided a cylindorical partition wall 33. Also a drain space 31 for collecting and draining the rinse liquid used in the rinsing process of the substrate W is formed to surround the circumference of the spin chuck 21. The drain space 31 is formed into a circular and groove form so as to follow the outer circumference of the spin chuck 21.

Furthermore, a liquid circulation space 32 for recovering a chemical solution used in the chemical solution process of the substrate W and allowing it to circulate in the substrate processing apparatus 100 is provided between the processing cup 23 and the partition wall 33 so as to surround the drain space 31. The liquid circulation space 32 is formed into a circular and groove form so as to follow the outer circumference of the drain space 31.

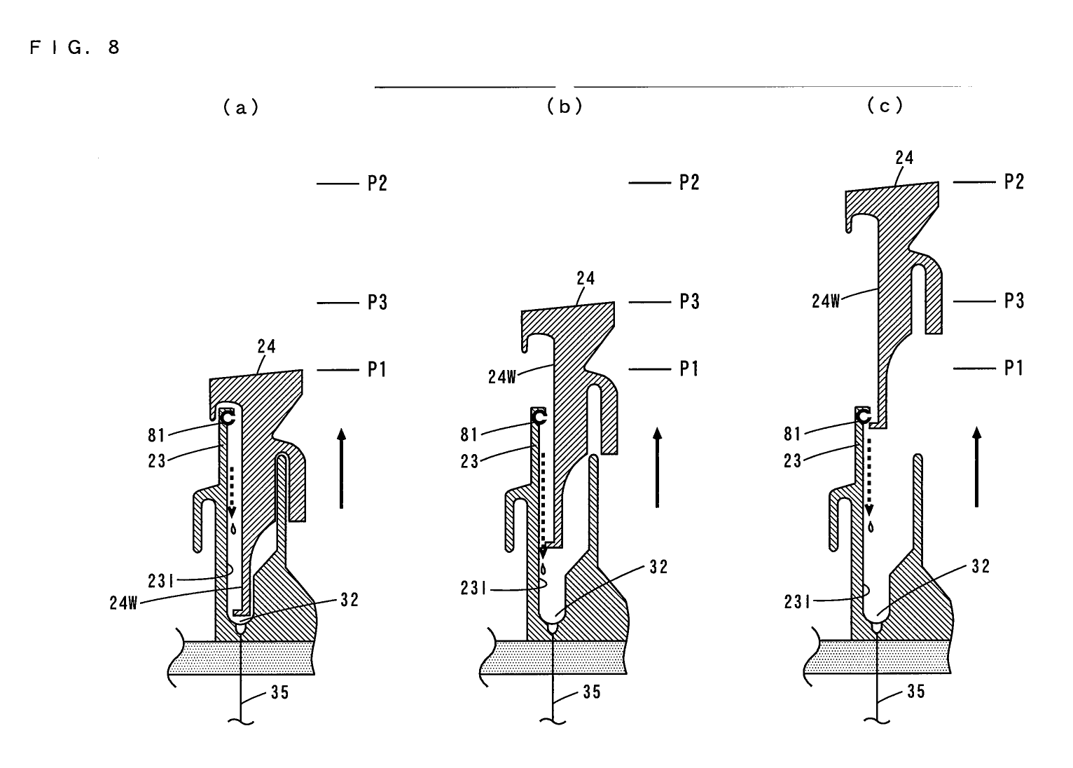

The drain space 31 is connected with a drain pipe 34 for leading the rinse liquid to a drain system pipe 130 in FIG. 8 as will be described later, and the liquid circulation space 32 is connected with a recovery pipe 35 for leading a chemical solution to a circulation system pipe 120A in FIG. 8 as will be described later.

Above the processing cup 23, a splash guard 24 is provided for preventing the chemical solution or the rinse liquid from the substrate W from scattering outwardly. This splash guard 24 has a rotation symmetric shape with respect to the rotary shaft 25. In the inner face of the upper end of the splash guard 24, a drain guiding groove 41 having a generally V-shaped cross section is annularly formed.

In the inner face of the lower end of the splash guard 24, a recovery liquid guiding part 42 formed of a slant face which is inclined outwardly and downwardly is provided. Near the upper end of the recovery liquid guiding part 42, a partition wall-housing groove 43 for receiving the partition wall 33 of the processing cup 23 is formed.

The splash guard 24 is supported by a guard lifting mechanism 37 composed of a ball screw mechanism or the like. The guard lifting mechanism 37 moves up and down the splash guard 24 among a carrying in and out position P1 in which the upper end of the splash guard 24 is at approximately the same level or lower than the upper end of the spin chuck 21, a circulation position P2 in which the recovery liquid guiding part 42 is opposite to the outer circumference of the substrate W held by the spin chuck 21, and a drain position P3 in which the drain guiding groove 41 is opposite to the outer circumference of the substrate W held by the spin chuck 21.

When the substrate W is carried on the spin chuck 21 and when the substrate W is carried out from the spin chuck 21, the splash guard 24 descends to the carrying in and out position P1.

When the splash guard 24 is in the circulation position P2, the chemical solution scattering outwardly from the substrate W is led to the liquid circulation space 32 by the recovery liquid guiding part 42 and fed to the circulation system pipe 120A via the recovery pipe 35.

On the other hand, when the splash guard 24 is in the drain position P3, the rinse liquid scattering outwardly from the substrate W is led to the drain space 31 by the drain guiding groove 41 and drained out through the drain pipe 34.

On the upper end of the processing cup 23, guard cleaning nozzles 81 having a circular shape are provided along the outer circumference of the processing cup 23. The guard cleaning nozzles 81 are supplied with a first cleaning liquid from the fluid box 2a-2d via guard cleaning supply pipes 82. The guard cleaning nozzles 81 inject (discharges) the first cleaning liquid to an outer wall face 24W of the splash guard 24. Thus, the outer wall face 24W of the splash guard 24 is cleaned.

The first cleaning liquid injected to the outer wall face 24W of the splash guard 24 flows down along the outer wall face 24W and then led to the liquid circulation space 32 directly or along an inner wall face 23I of the processing cup 23. Thus, the members (such as inner wall face of the processing cup 23) are also cleaned which are located in the path through which the first cleaning liquid flows. The details will be described later.

In the present embodiment, as the first cleaning liquid to be injected to the splash guard 24, for example, the chemical solution (BHF) which is used for the chemical solution process is used.

Further, the first cleaning liquid may be mixed with a gas such as air or an inert gas. In the present embodiment, as the first cleaning liquid to be injected to the splash guard 24, the chemical solution used in the chemical solution process is used, and the first cleaning liquid is mixed with N₂ which is an inert gas. The details will be described later.

(3) Structure of Guard Cleaning Nozzle and Attachment to Processing Cup

The details of the structure of a guard cleaning nozzle 81 and the details of the cleaning operation of the splash guard 24 by the guard cleaning nozzle 81 will be explained.

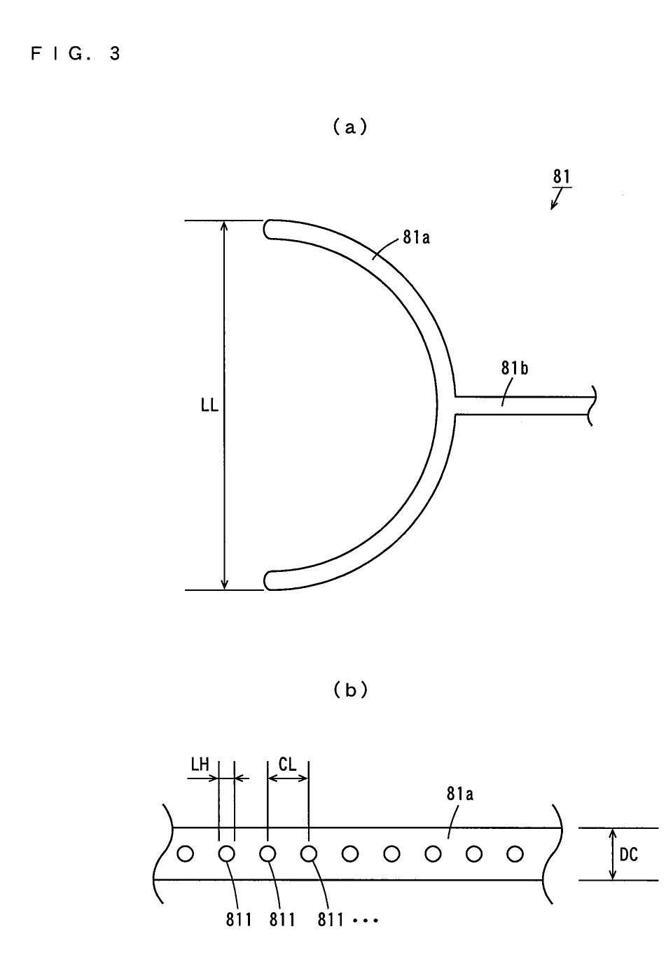

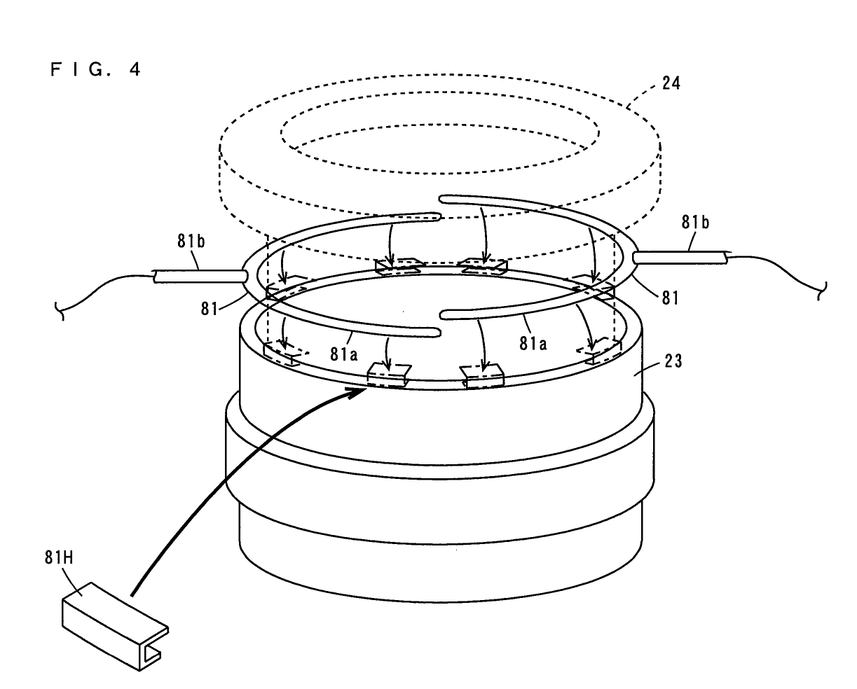

FIG. 3 is a view for explaining a structure of a guard cleaning nozzle 81 of FIG. 2, and FIG. 4 is a view for explaining attachment of the guard cleaning nozzles 81 of FIG. 2 to the processing cup 23.

FIG. 3(a) is a top view of the guard cleaning nozzle 81. The guard cleaning nozzle 81 used in the present embodiment is made from a tube of, for example, a fluorine resin such as PTFE (polytetrafluoroethylene) or PFA (tetrafluoroethylene perfluoroalkoxy vinyl ether copolymer).

Further, the guard cleaning nozzle 81 has a guard opposite part 81a extending in a semicircular shape, and a supply pipe connecting part 81b which extends outwardly from an approximate the center of the guard opposite part 81a and is connected to the guard cleaning supply pipe 82 shown in FIG. 2.

As shown in FIG. 4, on the upper end of the processing cup 23, two guard cleaning nozzles 81 are provided so as to be opposite to each other.

More specifically, a plurality of nozzle holders 81H are attached to the upper end of the processing cup 23 by means of, for example, screws. Then the two guard cleaning nozzles 81 are attached to the nozzle holders 81H.

The nozzle holders 81H have a block-C shaped cross section, and attachment of the guard cleaning nozzles 81 to the nozzle holders 81H is achieved by fitting the guard opposite parts 81a of the guard cleaning nozzles 81 into the nozzle holders 81H.

FIG. 3(b) is an enlarged view of the inner peripheral side of the guard opposite part 81a shown in FIG. 3(a). As can be seen in the figure, a plurality of cleaning liquid injection openings 811 are provided at predetermined intervals on the inner circumferential side of the guard opposite part 81a.

An outer diameter LL of the semicircle formed in the guard opposite part 81a is selected depending on the size of the processing cup 23. In the present embodiment, the outer diameter LL of the guard opposite part 81a is set, for example, at about 460 mm.

A tube outer diameter DC of the guard opposite part 81a is, for example, 8 mm. In this case, a hole diameter LH of the plurality of cleaning liquid injection openings 811 formed in the guard opposite part 81a is preferably set within the range of 0.5 mm to 1.5 mm, and more preferably set at the 1.0 mm.

An interval CL between adjacent cleaning liquid injection openings 811 is preferably set within the range from 2.5 mm to 10.0 mm, and more preferably it is set at 5.0 mm.

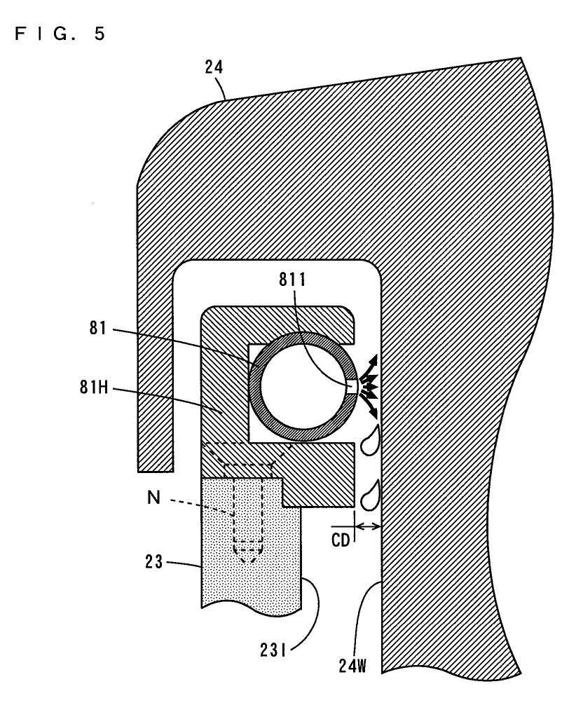

FIG. 5 is an enlarged sectional view showing the state in which the guard cleaning nozzle 81 is attached to the upper end of the processing cup 23.

As shown in FIG. 5, a nozzle holder 81H having a block C-shaped cross section is attached to the upper end of the processing cup 23 by a screw N, and the guard cleaning nozzle 81 is fitted into the nozzle holder 81H.

The nozzle holder 81H is provided such that a part thereof protrudes from the inner wall face 23I of the processing cup 23 toward the outer wall face 24W of the splash guard 24. A clearance CD is formed between the nozzle holder 81H and the outer wall face 24W of the splash guard 24. The clearance CD is set, for example, at about 2 mm.

In this state, the cleaning liquid injection openings 811 of the guard cleaning nozzle 81 is opposite to the outer wall face 24W of the splash guard 24. The first cleaning liquid is supplied through the aforementioned guard cleaning supply pipe 82 (FIG. 2) injected from the cleaning liquid injection openings 811 of the guard cleaning nozzle 81.

The first cleaning liquid injected through the cleaning liquid injection openings 811 comes into collision with the outer wall face 24W of the splash guard 24 to remove the precipitates (hereinafter, referred to as “deposit”) of the chemical solution adhering to the outer wall face 24W of the splash guard 24.

The first cleaning liquid having come into collision with the outer wall face 24W flows down along both or either one of the inner wall face 23I of the processing cup 23 and the outer wall face 24W of the splash guard 24, and then is led to the liquid circulation space 32 in FIG. 2.

When the first cleaning liquid having come into collision with the outer wall face 24W flows down along the inner wall face 23I of the processing cup 23, the deposit on the inner wall face 23I is washed out downwardly by the first cleaning liquid.

When the first cleaning liquid having come into collision with the outer wall face 24W flows along the outer wall face 24W of the splash guard 24, the deposit on the outer wall face 24W is washed out downwardly by the first cleaning liquid.

As described above, in the present embodiment, a liquid having the same ingredients as the chemical solution used in the chemical solution process is employed as the first cleaning liquid. Thus, the first cleaning liquid led to the liquid circulation space 32 can be fed to the circulation system pipe 120A via the recovery pipe 35 as is the case with the recovery of the chemical solution.

Now, explanation will be made of timing of cleaning of the outer wall face 24W of the splash guard 24 by the guard cleaning nozzles 81.

(4) Timing of Cleaning of Splash Guard

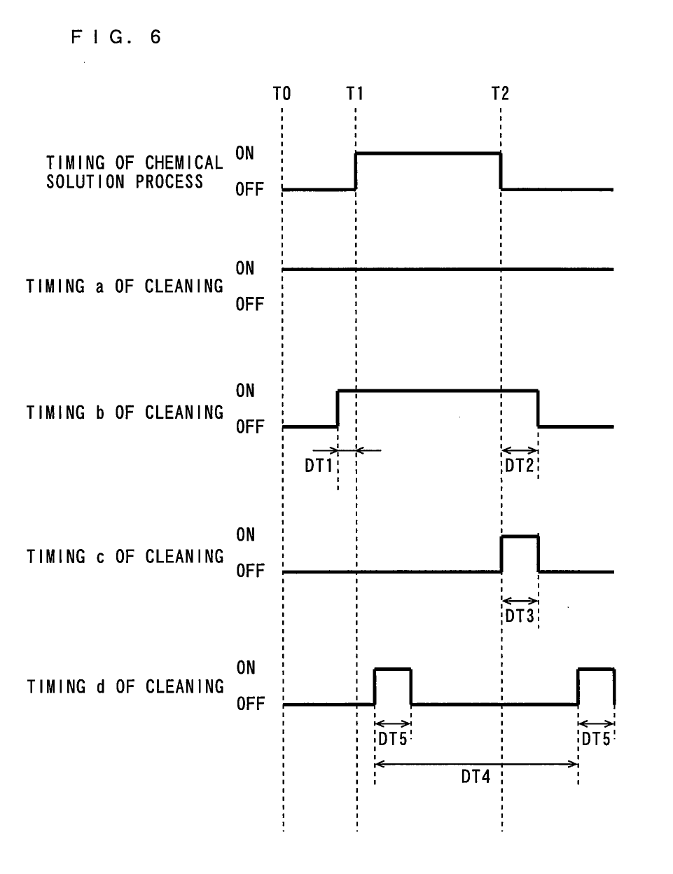

The cleaning of the splash guard 24 by the guard cleaning nozzle 81 is performed, for example, in the following timing. FIG. 6 is a view showing a plurality of examples of timing of cleaning of the splash guard 24.

In FIG. 6, a plurality of timings a-d of cleaning are shown chronologically together with the timing of the chemical solution process. In FIG. 6, the symbol T0 denotes an operation starting time of the substrate processing apparatus 100, and the symbol T1 denotes a start (ON) time of a chemical solution process, and the symbol T2 denotes an end (OFF) time of the chemical solution process.

The timings a-d of cleaning are set, for example, in the controller 4 of FIG. 1. Thus, the controller 4 controls the constituent elements of each of the cleaning processing units 5a-5d based on the set timing of cleaning to perform a cleaning process of the splash guard 24.

According to the timing a of cleaning in FIG. 6, cleaning of the splash guard 24 is always performed during operation of the substrate processing apparatus 100. In this case, cleaning of the splash guard 24 is started (ON) concurrently with starting of operation of the substrate processing apparatus 100. The cleaning of the splash guard 24 (ON state) is kept without being influenced by start (ON) and end (OFF) of the chemical solution process.

When the timing a of cleaning is set in the manner as described above, it is possible to sufficiently prevent a chemical solution from adhering to the outer wall face 24W of the splash guard 24 or to the inner wall face 23I of the processing cup 23 to generate precipitates of the chemical solution. Thus, generation of particles from deposit of the chemical solution is prevented.

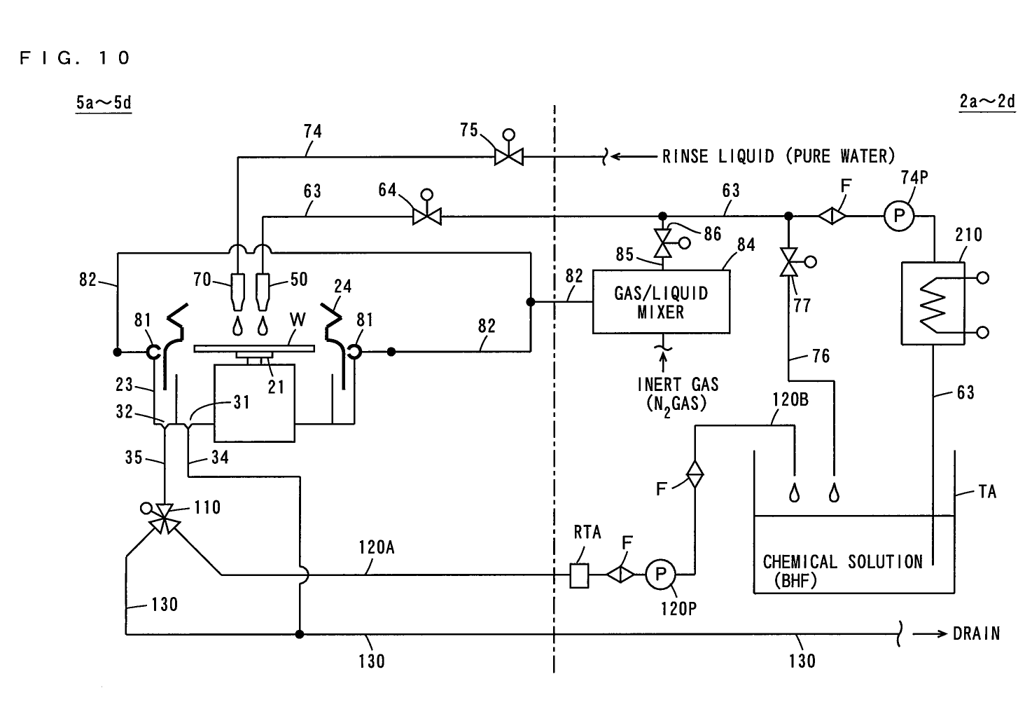

According to this timing a of cleaning, since supply of the first cleaning liquid from the guard cleaning nozzle 81 is kept without being influenced by start/end of the chemical solution process, a problem of consumption of the first cleaning liquid may arise. However, since the chemical solution and the first cleaning liquid have the same ingredients, the first cleaning liquid can be recovered and reused by providing a mechanism for recovering and reusing the chemical solution and the first cleaning liquid (a path consisting of a recovery pipe 35, circulation system pipes 120A, 120B, a recovery tank RTA, a pump 120P, a chemical solution storage tank TA and the like as shown in later-described FIG. 10 (hereinafter, referred to as a recovery path)). Therefore, wasteful consumption of the first cleaning liquid can be prevented.

According to the timing b of cleaning in FIG. 6, in the cleaning processing unit 5a-5d, cleaning of the splash guard 24 is performed at least during the period in which the chemical solution process is performed (ON period). In this case, cleaning of the splash guard 24 is started (ON) before a predetermined time DT1 from time T1 at which the chemical solution process starts (ON), for example. Cleaning of the splash guard 24 (ON state) is kept until a lapse of a predetermined time DT2 from time T2 at which the chemical solution process ends (OFF). When the predetermined time DT2 has lapsed from time T2, cleaning of the splash guard 24 ends (OFF).

When the timing b of cleaning is set in the manner as described above, it is possible to sufficiently prevent the chemical solution from adhering to the outer wall face 24W of the splash guard 24 or to the inner wall face 23I of the processing cup 23 to generate precipitates of the chemical solution. As a result, generation of particles from deposits of the chemical solution is prevented. The predetermined time DT1 is preferably set at 1 sec., for example, and the predetermined time DT2 is preferably set at 5 sec., for example.

According to the timing b of cleaning, supply of the first cleaning liquid from the guard cleaning nozzle 81 is kept at least during the period in which the chemical solution process is performed, however, similarly to the timing a of cleaning as described above, the first cleaning liquid may be recovered and reused by providing a recovery path as described above. Therefore, wasteful consumption of the first cleaning liquid can be avoided.

According to the timing c of cleaning in FIG. 6, in the cleaning processing unit 5a-5d, the splash guard 24 is cleaned during a predetermined period from the end (OFF) of the chemical solution process. In this case, for example, cleaning of the splash guard 24 is started (ON) at time T2 when the chemical solution process ends (OFF). Cleaning of the splash guard 24 (ON state) is kept until a predetermined time DT3 has lapsed from the time T2 when the chemical solution process ends (OFF).

When the timing c of cleaning is set in the manner as described above, wasteful consumption of the first cleaning liquid is prevented. Further, it is possible to prevent the chemical solution from adhering to the outer wall face 24W of the splash guard 24 or to the inner wall face 23I of the processing cup 23 to generate precipitates of the chemical solution. The predetermined time DT3 is preferably set, for example, within the range of 1-5 sec.

In the timing c of cleaning, by providing a recovery path similarly to the cases of the above timings a, b of cleaning, wasteful consumption of the first cleaning liquid can be further prevented. When such a recovery path is provided, since the amount of the first cleaning liquid is small compared to the cases of the timings a, b of cleaning, it is possible to prevent the first cleaning liquid from being oxidized by the atmosphere and deteriorated, compared to the cases of timings a, b of cleaning.

According to the timing d of cleaning in FIG. 6, the splash guard 24 is intermittently cleaned in the cleaning processing unit 5a-5d regardless of the timing of the chemical solution process. In the example of FIG. 6, cleaning of the splash guard 24 starts (ON) at intervals of the time DT4, and cleaning of the splash guard 24 ends (OFF) when the predetermined time DT5 has lapsed.

When the timing d of cleaning is set in the manner as described above, wasteful consumption of the first cleaning liquid is prevented. Further, it is possible to prevent the chemical solution from adhering to the outer wall face 24W of the splash guard 24 or to the inner wall face 23I of the processing cup 23 to generate precipitates of the chemical solution. As a result, generation of particles from deposits of the chemical solution is prevented. The predetermined time DT4 is preferably set, for example, at 5 min., and the predetermined time DT5 is preferably set, for example, within the range of 1-5 sec.

Also in the timing d of cleaning, by providing a recovery path similarly to the cases of the above timings a, b of cleaning, wasteful consumption of the first cleaning liquid can be further prevented. When such a recovery path is provided, it is possible to prevent the first cleaning liquid from being oxidized by the atmosphere and deteriorated, compared to the cases of timings a, b of cleaning.

Besides the above, the cleaning processing unit 5a-5d shown in FIG. 2 may be provided with a deposit detector that detects deposits on the splash guard 24, and the timing of cleaning may be set based on the detection by the deposit detector.

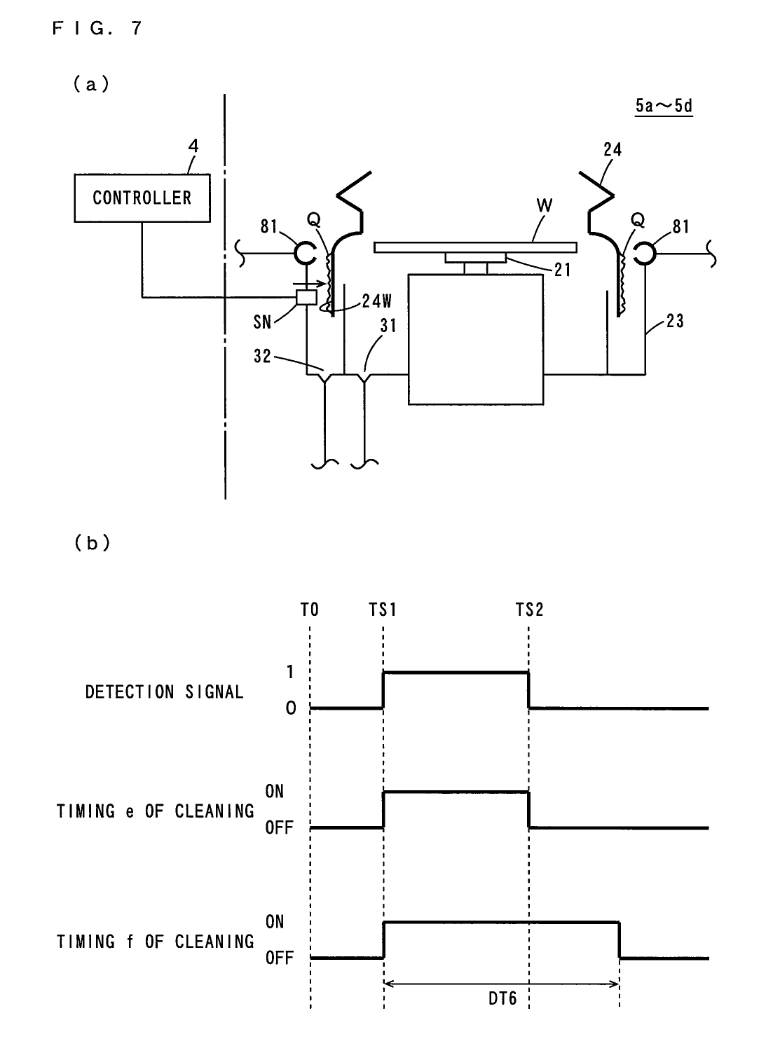

FIG. 7 is a view for explaining the timing of cleaning when a deposit detector is used.

FIG. 7(a) shows a diagram of the cleaning processing unit 5a-5d to which a deposit detector SN is attached. Here, the deposit detector SN is a detector that detects change in surface condition of the outer wall face 24W of the splash guard 24, and, for instance, the deposit detector SN detects presence/absence of deposits Q based on change in color of the outer wall face 24W or change in reflectivity of the outer wall face 24W.

The deposit detector SN provides the controller 4 with a detection signal of logical “1” indicative of presence of deposits Q on the outer wall face 24W when it detects change in surface condition of the outer wall face 24W exceeding a predetermined threshold. Also, the deposit detector SN provides the controller 4 with a detection signal of logical “0” indicative of absence of deposits Q on the outer wall face 24W when it detects change in surface condition of the outer wall face 24W not exceeding the predetermined threshold.

FIG. 7(b) shows in a time series a plurality of timings e, f of cleaning based on detection signals together with the detection signals. In FIG. 7(b), the symbols T0 denotes an operation starting time of the substrate processing apparatus 100, the symbols TS1 denotes time when the deposit detector SN detects presence of deposits Q (logical “1”), the symbols TS2 denotes time when the deposit detector SN no longer detects presence of deposits Q (logical “0”).

According to the timing e of cleaning in FIG. 7, in the cleaning processing unit 5a-5d, the splash guard 24 is cleaned at least during the period in which deposits Q on the outer wall face 24W are detected. In this case, cleaning of the splash guard 24 is started (ON) when the deposit detector SN provides the controller 4 with the detection signal of logical “1”, for example. Cleaning of the splash guard 24 (ON state) is continued until the detection signal of logical “0” from the deposit detector SN is provided to the controller 4. Therefore, cleaning of the splash guard 24 is stopped (OFF) when the deposit detector SN provides the controller 4 with the detection signal of logical “0”.

When such a timing e of cleaning is set in this manner, wasteful consumption of the first cleaning liquid is prevented. Further, it is possible to prevent the chemical solution from adhering to the outer wall face 24W of the splash guard 24 or to the inner wall face 23I of the processing cup 23 to generate precipitates of the chemical solution. As a result, generation of particles from deposits of the chemical solution is prevented.

According to the timing f of cleaning in FIG. 7, in the cleaning processing unit 5a-5d, cleaning of the splash guard 24 is performed for a predetermined period DT6 from the time when deposits Q are detected on the outer wall face 24W or on the inner wall face 23I of the processing cup 23. In this case, for example, cleaning of the splash guard 24 is started (ON) when the deposit detector SN provides the controller 4 with the detection signal of logical “1”. Cleaning of the splash guard 24 (ON state) is stopped (OFF) after the predetermined period DT6 has lapsed.

When such a timing f of cleaning is set in this manner, wasteful consumption of the first cleaning liquid is prevented. Further, it is possible to prevent the chemical solution from adhering to the outer wall face 24W of the splash guard 24 or to the inner wall face 23I of the processing cup 23 to generate precipitates of the chemical solution. As a result, generation of particles from deposits of the chemical solution is prevented. The predetermined time DT6 is preferably set within the range of 10 to 60 sec.

(5) Details of Cleaning of Splash Guard

Here, an explanation of the cleaning process of the splash guard 24 will be made when the splash guard 24 is elevated by the guard lifting mechanism 37 in the state that the timing a of cleaning described above is set, and cleaning of the splash guard 24 is continuously performed during the operation of the substrate processing apparatus 100.

FIG. 8 is a view showing a cleaning process of the splash guard 24.

In the cleaning processing unit 5a-5d of FIG. 2 in this example, a substrate W is first carried on the spin chuck 21. Then the substrate W held by the spin chuck 21 is provided with the chemical solution, and the chemical solution process is performed. Then the rinse liquid is supplied to the substrate W and the rinsing process is performed. The substrate W subjected to the rinsing process is rotated by the spin chuck 21 and dried by shaking off (hereinafter, referred to as drying process). Then the substrate W is carried out from the spin chuck 21. The splash guard 24 is always supplied with the first cleaning liquid from the starting of operation of the substrate processing apparatus 100.

The splash guard 24 is moved up or down by the guard lifting mechanism 37 in accordance with such predetermined process steps.

FIGS. 8(a)-(c) show in a time series positional relationships between the processing cup 23 and the splash guard 24 before starting of the chemical solution process after carrying of the substrate W onto the spin chuck 21.

As shown in FIG. 8(a), in performing the chemical solution process, first, the splash guard 24 starts elevating from the carrying in and out position P1. Thus, the vicinity of the upper end of the outer wall face 24W of the splash guard 24 is cleaned with the first cleaning liquid.

The first cleaning liquid injected from the guard cleaning nozzle 81 will flow down along the inner wall face 23I of the processing cup 23 after coming into collision with the outer wall face 24W of the splash guard 24 and reflecting toward the inner wall face 23I of the processing cup 23. Thus, the inner wall face 23I of the processing cup 23 is also cleaned with the first cleaning liquid.

As shown in FIG. 8(b), as the splash guard 24 elevates, almost the center of the outer wall face 24W is cleaned with the first cleaning liquid injected from the guard cleaning nozzle 81.

Thus, when the splash guard 24 elevates to the circulation position P2, the first cleaning liquid is injected to the entire region of the outer wall face 24W in the vertical direction as shown in FIG. 8(c), and thus the entire region of the outer wall face 24W is cleaned.

Further, by continuously supplying the first cleaning liquid from the guard cleaning nozzle 81, the chemical solution remaining in the vicinity of the lower end of the inner wall face 23I of the processing cup 23 (liquid circulation space 32) is washed out to the recovery pipe 35 by the first cleaning liquid.

(6) Injecting of First Cleaning Liquid by Guard Cleaning Nozzle

As described above, a gas such as air or an inert gas is mixed into the first cleaning liquid to be injected to the outer wall face 24W of the splash guard 24 from the guard cleaning nozzle 81.

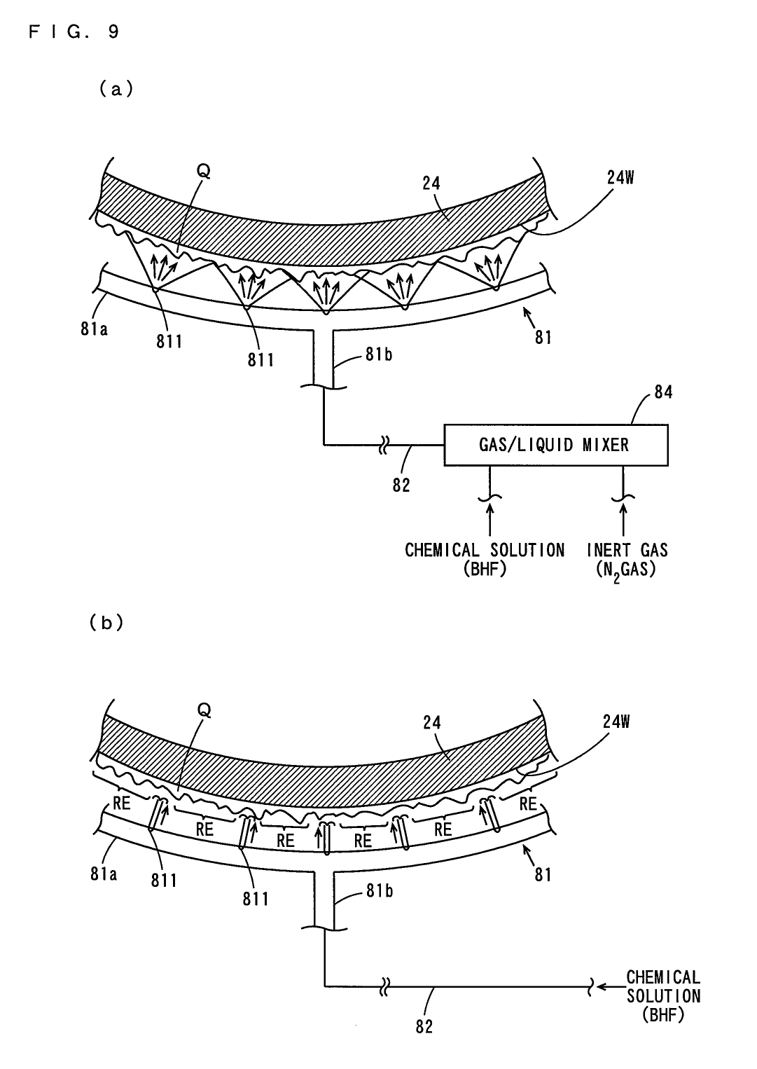

FIG. 9 is a view for explaining the effects of mixing a gas into the first cleaning liquid to be injected from the guard cleaning nozzle 81.

As shown in FIG. 9(a), a gas/liquid mixer 84 having at least either one of an in-line mixer or a mixing valve is connected to the guard cleaning supply pipe 82 connected to the guard cleaning nozzle 81. This gas/liquid mixer 84 is supplied with the chemical solution (BHF) used in the chemical solution process as the first cleaning liquid and with N₂ (nitrogen) gas as an inert gas. This makes it possible to supply the guard cleaning nozzle 81 with a mixture fluid of the first cleaning liquid and the inert gas which is generated in the gas/liquid mixer 84.

Here, the mixing condition of the first cleaning liquid and the inert gas is adjusted such that microbubbles of the inert gas are dispersed in the first cleaning liquid. In this case, the bubbles compressed by the inner pressure of the guard cleaning nozzle 81 will be expanded by being injected through the first cleaning liquid injection openings 811. Accordingly, as shown in FIG. 9(a), the first cleaning liquid is injected at a large spread angle from the plurality of cleaning liquid injection openings 811. Thus, it is possible to inject the first cleaning liquid circumferentially of the outer wall face 24W of the splash guard 24 without leaving any spaces. Thus, it is possible to clean the entire face of the outer wall face 24W by elevation of the splash guard 24.

In contrast, as shown in FIG. 9(b), when only the first cleaning liquid is supplied to the guard cleaning nozzle 81, the first cleaning liquid supplied to the guard cleaning nozzle 81 is injected linearly toward the outer wall face 24W from the cleaning liquid injection openings 811.

In this case, although the portions of the outer wall face 24W of the splash guard 24 opposite to the cleaning liquid injection openings 811 of guard cleaning nozzle 81 can be cleaned, the other regions RE are difficult to be cleaned. Therefore, even when the splash guard 24 elevates, deposits Q on the splash guard 24 are likely to remain in the regions extending vertically in stripes. In this case, by increasing the flow amount of the first cleaning liquid to be injected from the cleaning liquid injection openings 811 of the guard cleaning nozzle 81, it is possible to clean the entire face of the splash guard 24.

As the gas/liquid mixer 84, an in-line mixer or a mixing valve are exemplified, however, any joining members that can join the chemical solution and the inert gas, for example, T-shaped joint with which a supply pipe of chemical solution, a supply pipe of inert gas, and the guard cleaning supply pipe 82 is connected can be used.

(7) Reuse and Drain of Various Chemical Solutions

FIG. 10 is a system diagram of piping of the substrate processing apparatus 100 in FIG. 1.

As shown in FIG. 10, to the rinse nozzle 50 of the cleaning processing unit 5a-5d, the supply pipe 74 for rinsing process extending to the fluid box 2a-2d is connected.

A valve 75 is inserted in the supply pipe 74 for rinsing process. In the fluid box 2a-2d, pure water is supplied as the rinse liquid to the supply pipe 74 for rinsing process. Thus, the rinse liquid can be supplied to the substrate W by operating the valve 75.

To the chemical solution nozzle 50 of the cleaning processing unit 5a-5d, the supply pipe 63 for chemical solution process extending to the chemical solution storage tank TA in the fluid box 2a-2d is connected.

The valve 64 is inserted in the supply pipe 63 for chemical solution process, and in the fluid box 2a-2d, a filter F, a pump 74P and a temperature controller 210 are inserted in the supply pipe 63 for chemical solution process in this order from the valve 64. In the chemical solution storage tank TA, BHF is stored as the chemical solution.

When the pump 74P inserted in the supply pipe 63 for chemical solution process is operated, the chemical solution in the chemical solution storage tank TA is fed to the temperature controller 210 where it is controlled to have a predetermined temperature. Then the chemical solution of which temperature has been adjusted is fed to the valve 64 via the pump 74P and the filter F. Accordingly, the chemical solution can be supplied to the substrate W by operating the valve 64.

In the fluid bo 2 a-2d, one end of the pipe 76 is connected to a portion between the valve 64 and the pump 74P of the supply pipe 63 for chemical solution process. The other end of the pipe 76 extends to the chemical solution storage tank TA. A valve 77 is inserted in the pipe 76.

Further, in the fluid box 2a-2d, one end of pipe 85 is connected to a portion between the valve 64 and the pump 74P of the supply pipe 63 for chemical solution process the gas/liquid mixer 84 is connected to the other end of the pipe 85. A valve 86 is inserted in the pipe 85.

When the valve 77 is opened while the valve 64 and the valve 86 are closed, the chemical solution pumped from the chemical solution storage tank TA will be stored again in the chemical solution storage tank TA without being fed to the cleaning processing unit 5a-5d. In this manner, since the chemical solution circulates the chemical solution storage tank TA, the supply pipe 63 for chemical solution process, the pump 74P, the filter F, the temperature controller 210 and the pipe 76, the chemical solution in the chemical solution storage tank TA is kept at a predetermined temperature by the temperature controller 210 and kept clean by the filter F.

As described above, to two guard cleaning nozzles 81 of the cleaning processing unit 5a-5d, the guard cleaning supply pipe 82 is connected. The guard cleaning supply pipe 82 extends to the fluid box 2a-2d.

In this example, the guard cleaning supply pipe 82 is a branched pipe made up of one main pipe and two branched pipes. To each of two guard cleaning nozzles 81, a branched pipe of the guard cleaning supply pipe 82 is connected.

The main pipe of the guard cleaning supply pipe 82 is connected to the gas/liquid mixer 84 in the fluid box 2a-2d. This gas/liquid mixer 84 is supplied with BHF as the first cleaning liquid by opening the valve 86. Further, the gas/liquid mixer 84 is supplied with N₂ gas serving as the inert gas.

In this way, it is possible to supply the two guard cleaning nozzles 81 with the mixture fluid of the first cleaning liquid of the inert gas. Accordingly, it is possible to inject the first cleaning liquid to the outer wall face 24W of the splash guard 24 (FIG. 2) at a large spread angle.

To the drain space 31 in the processing cup 23, one end of the drain pipe 34 is connected. The other end of the drain pipe 34 is connected to a drain system pipe 130 which will be described later.

To the liquid circulation space 32 in the processing cup 23, one end of the recovery pipe 35 is connected. The other end of the recovery pipe 35 is connected to a three-way valve 110. To this three-way valve 110, the circulation system pipe 120A and the drain system pipe 130 are connected.

The circulation system pipe 120A is connected with a recovery tank RTA provided in the fluid box 2a-2d, and the chemical solution introduced to the circulation system pipe 120A is temporarily stored in the recovery tank RTA.

To the recovery tank RTA, the circulation system pipe 120B is connected, and the circulation system pipe 120B extends from the recovery tank RTA to the chemical solution storage tank TA in the fluid box 2a-2d. In the fluid box 2a-2d, a pump 120P is inserted in the circulation system pipe 120B, and two filters F are inserted therein so as sandwich the pump 120P.

The drain system pipe 130 extends from the cleaning processing unit 5a-5d to the inside of the fluid box 2a-2d or to the drain device (not shown) provided external to the substrate processing apparatus 100.

The three-way valve 110 is controlled so as to lead the chemical solution and the first cleaning liquid flowing into the recovery pipe 35 to the circulation system pipe 120A during the chemical solution process of the substrate W and during the cleaning of the outer wall face 24W of the splash guard 24 and the inner wall face 23I of the processing cup 23. In this way, the internal space of the recovery pipe 35 and the internal space of the circulation system pipe 120A communicate via the three-way valve 110. In this case, the chemical solution and the first cleaning liquid will not flow to the drain system pipe 130.

The chemical solution and the first cleaning liquid introduced to the circulation system pipe 120A is temporarily stored in the recovery tank RTA. The chemical solution stored in the recovery tank RTA is fed to the chemical solution storage tank TA by the pump 120P through the circulation system pipe 120B and cleaned through the filter F. Thus, the chemical solution used for the chemical solution process and the first cleaning liquid used for the cleaning of the splash guard 24 are stored again in the chemical solution storage tank TA.

In the present embodiment, operations of the aforementioned three-way valve 110, valves 64, 75, 77, pumps 74P, 120P and temperature controller 210 are controlled by the controller 4 shown in FIG. 1.

As described above, in the substrate processing apparatus 100 according to the present embodiment, the chemical solution used in the chemical solution process is circulated and reused. Therefore, by reusing the chemical solution which is more expensive than the rinse liquid, production cost of the substrate W is reduced.

Further, in the present embodiment, as described above, as the first cleaning liquid for the splash guard 24, the one having the same ingredients with the chemical solution used in the chemical solution process is used. Thus, the chemical solution used in the chemical solution process can be reused as the first cleaning liquid for the splash guard 24, or the first cleaning liquid used in the cleaning of the splash guard 24 can be used as the chemical solution for the chemical solution process. Therefore, production cost of the substrate W will not rise even when the chemical solution is used for the cleaning of the splash guard 24.

In the present embodiment, the three-way valve 110 may not be provided, and the circulation system pipe 120A may be directly connected to the other end of the recovery pipe 35 instead of the three-way valve 110.

(8) Effects

In the substrate processing apparatus 100 according to the present embodiment, the process of the substrate W is performed while the chemical solution is supplied to the substrate W held by the spin chuck 21 by the chemical solution nozzle 50. At this time, the chemical solution supplied to the substrate W scatters around and adheres to the members (the processing cup 23 and the splash guard 24) located in the periphery of the substrate W.

Such adhesion of the chemical solution to the peripheral members of the substrate W may cause adhesion of precipitates of the chemical solution on the outer wall face 24W of the splash guard 24 and the inner wall face 23I of the processing cup 23.

In view of this, the first cleaning liquid having the same ingredients with the chemical solution is supplied from the guard cleaning nozzles 81 to the outer wall face 24W of the splash guard 24 and the inner wall face 23I of the processing cup 23 without being in contact with the substrate W. Thus, the outer wall face 24 W of the splash guard 24 and the inner wall face 23I of the processing cup 23 are cleaned with the clean first cleaning liquid.

Further, since the outer wall face 24W of the splash guard 24 and the inner wall face 23I of the processing cup 23 are cleaned with the first cleaning liquid having the same ingredients as the chemical solution, it is possible to clean the lower end of the outer wall face 24W of the splash guard 24 and the inner wall face 23I of the processing cup 23 during the process of the substrate W, namely when the chemical solution is supplied to the substrate W held by the spin chuck 21. Therefore, it is possible to efficiently clean the lower end of the outer wall face 24W of the splash guard 24 and the inner wall face 23I of the processing cup 23 without deterioration in throughput of the substrate processing.

Even when the chemical solution remains in the liquid circulation space 32, drying and precipitation of the chemical solution can be prevented by supplying the first cleaning liquid having the same ingredients as the chemical solution that remains. Thus, generation of particles due to adhesion of precipitates of the chemical solution in the vicinity of the liquid circulation space 32 of the processing cup 23 can be prevented.

In this way, processing defects of the substrate W are sufficiently prevented by preventing generation of particles from the precipitates of the chemical solution.

Further, the chemical solution supplied to the substrate W and the first cleaning liquid supplied to the outer wall face 24W of the splash guard 24 and the inner wall face 23I of the processing cup are reused. Accordingly, production cost of the substrate W is reduced.

(9) Chemical Solution and First Cleaning Liquid Used in Substrate Processing Apparatus

In the present embodiment, BHF is used, for example, for etching and cleaning the surface of the substrate W. Other examples of the chemical solution will be listed below.

As the chemical solution, a solution containing ammonium fluoride for removing polymer formed on the surface of the substrate W, for example, a mixture solution containing ammonium fluoride and phosphoric acid can be used.

When a solution containing a salt generated by mixing of an alkaline solution and an acidic solution, such as BHF used in the present embodiment or the mixture solution containing ammonium fluoride and phosphoric acid is used, precipitates is likely to occur.

Therefore, the present substrate processing apparatus offers a significant effect when the mixture solution of an alkaline solution and an acidic solution is used as the chemical solution.

An alkaline solution such as TMAH (tetra methyl ammonium hydroxide) or an acidic solution such as butyl acetate may also be used as the chemical solution for performing a development process of the substrate W.

Further, sulfuric acid/hydrogen peroxide mixture or ozone water may be used as a chemical solution for a removing resist formed on the surface of the substrate W.

Also BHF, DHF (diluted hydrofluoric acid), hydrofluoric acid, hydrochloric acid, sulfuric acid, nitric acid, phosphoric acid, acetic acid, oxalic acid, ammonia, citric acid, hydrogen peroxide water, or an aqueous solution of TMAH or the like, as well as mixtures thereof may be used as the chemical solution for etching or cleaning the surface of substrate W.

In the present embodiment, although the chemical solution used in the chemical solution process and the first cleaning liquid used in the cleaning of the splash guard 24 are the same, the first cleaning liquid having at least the same ingredients as the chemical solution used in the chemical solution process can be used, and these two solutions may have different temperatures and concentrations. Preferably, the concentration of the first cleaning liquid is substantially the same as that of the chemical solution used in the chemical solution process.

The expression “the same ingredients as the chemical solution” means that the proportions of ingredients other than pure water contained in the chemical solution are the same. When the concentration of the chemical solution differs from that of the first cleaning liquid, they may be reused in the chemical solution process or the cleaning process of the splash guard 24 by adjusting the concentration of either the chemical solution or the first cleaning liquid.

Therefore, when the concentrations of the chemical solution and the first cleaning liquid are set to be substantially equal in advance, they can be easily reused in the chemical solution process and in the cleaning process of the splash guard 24 without necessity of adjusting the concentration of the chemical solution or the concentration of the first cleaning liquid separately.

(10) Other Exemplary Structures

In the substrate processing apparatus 100 according to the present embodiment, the cleaning processing unit 5a-5d shown in FIG. 2 may further include the following elements.

(10-a) Nozzle Cleaning Nozzle

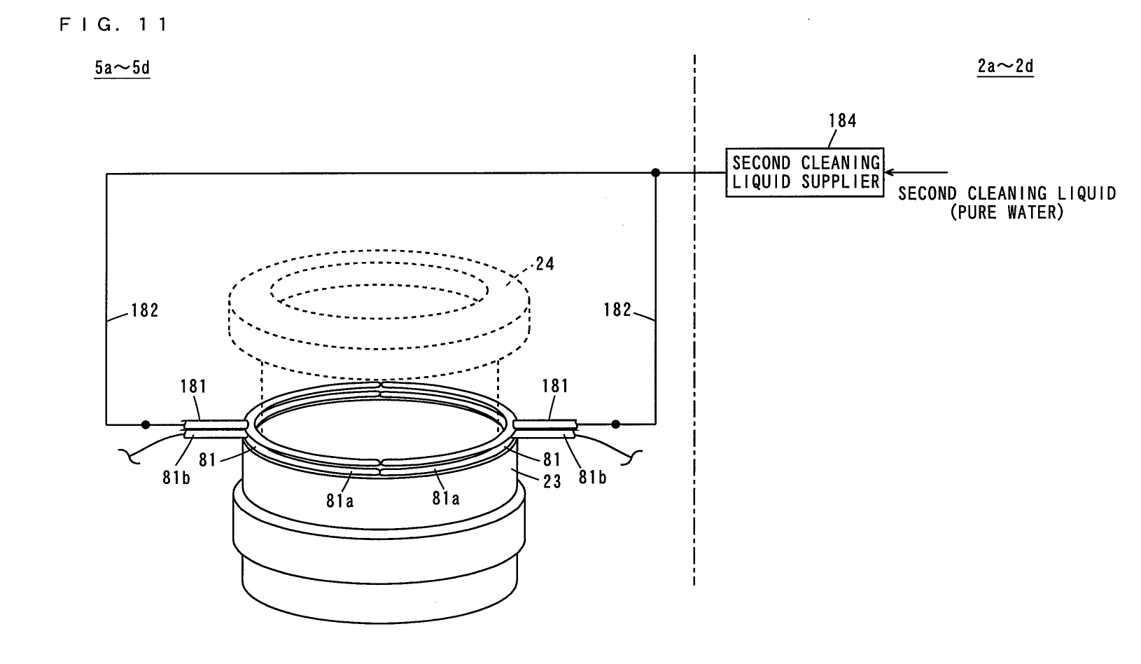

FIGS. 11 and 12 are views for explaining nozzle cleaning nozzles 181 for cleaning the guard cleaning nozzles 81 shown in FIG. 2. The nozzle cleaning nozzles 181 are attached to the upper end of the processing cup 23 together with the guard cleaning nozzles 81 in a similar manner as the guard cleaning nozzle 81.

FIG. 11 shows the appearance of the nozzle cleaning nozzles 181 and how the nozzle cleaning nozzles 181 are attached to the processing cup 23. FIG. 12 is an enlarged sectional view of the state in which a guard cleaning nozzle 81 and a nozzle cleaning nozzle 181 are attached to the upper end of the processing cup 23.

As shown in FIG. 11, in the present example, the nozzle cleaning nozzles 181 having substantially the same shape as the guard cleaning nozzles 81 are attached right above the guard cleaning nozzles 81.

Each nozzle cleaning nozzle 181 is provided with a plurality of cleaning liquid injection openings 181a similarly to the case of the guard cleaning nozzle 81, and the plurality of cleaning liquid injection openings 181a are formed in downwardly biased positions on the inner circumferential side of the nozzle cleaning nozzle 181.

Thus, when each nozzle cleaning nozzle 181 is attached to the processing cup 23 together with the guard cleaning nozzle 81 by the nozzle holder 81H as shown in FIG. 12, the plurality of cleaning liquid injection openings 181a face the vicinity of the cleaning liquid injection openings 811 of the guard cleaning nozzle 81 located right below the same.

The nozzle cleaning nozzles 181 are supplied with a second cleaning liquid (a liquid having ingredients different from that of the chemical solution for the chemical solution process and capable of dissolving the first cleaning liquid) from a second cleaning liquid supplier 184 provided in the fluid box 2a-2d through the nozzle cleaning supply pipes 182. In the present example, the second cleaning liquid is, for example, pure water.

Each nozzle cleaning nozzle 181 injects (discharges) the supplied second cleaning liquid to the vicinity of the plurality of cleaning liquid injection openings 811 of the guard cleaning nozzle 81. Thus, the vicinity of the cleaning liquid injection openings 811 of the guard cleaning nozzle 81 is cleaned.

Precipitates may be generated generate from the first cleaning liquid adhering to the vicinity of the cleaning liquid injection openings 811 of the guard cleaning nozzle 81 by cleaning of the outer wall face 24W of the splash guard 24.

In view of this, by cleaning the vicinity of the cleaning liquid injection openings 811 with the second cleaning liquid as described above, deposits Q of the cleaning liquid injection openings 811 are removed. As a result, generation of particles from deposits Q of the first cleaning liquid is prevented, and processing defects of substrate W are prevented.

In the present example, as shown in FIG. 12, the second cleaning liquid injected from the nozzle cleaning nozzle 181 passes through the vicinity of the cleaning liquid injection openings 811 of the guard cleaning nozzle 81 and comes into collision with the outer wall face 24W of the splash guard 24.

The second cleaning liquid having come into collision with the outer wall face 24W of the splash guard 24 flows down downwardly while being supplied to the inner wall face 23I of the processing cup 23. Accordingly, the outer wall face 24W of the splash guard 24 and the inner wall face 23I of the processing cup 23 are also cleaned with the second cleaning liquid. As a result, deposits Q of the chemical solution and the first cleaning liquid are removed from the outer wall face 24W of the splash guard 24 and the inner wall face 23I of the processing cup 23.

(10-b) Timing of Cleaning of Guard Cleaning Nozzle

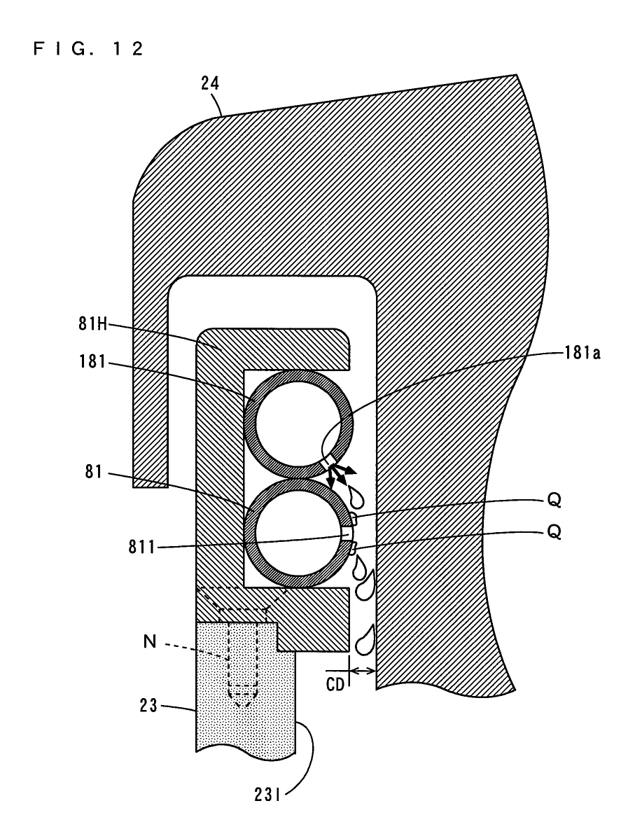

In the present embodiment, cleaning of the guard cleaning nozzles 81 by the nozzle cleaning nozzles 181 is performed, for example in the following timing. FIG. 13 is a view showing a plurality of examples of timing of cleaning of the guard cleaning nozzles 81.

In FIG. 13, two timings A, B of cleaning are shown in a time series together with the timings of the rinsing process and the drying process.

In FIG. 13, the symbols T0 denotes an operation starting time of the substrate processing apparatus 100, the symbols TR1 denotes a starting (ON) time of the rinsing process, and the symbols TR2 denotes an ending (OFF) time of the rinsing process. The reference numeral TD1 denotes a starting (ON) time of the drying process, and the symbols TD2 denotes an ending (OFF) time of the drying process.

The timings A, B of cleaning are set in the controller 4, as shown in FIG. 1, for example. Thus, the controller 4 controls the elements of each of the cleaning processing units 5a-5d based on the set timing of cleaning to perform the cleaning process of the guard cleaning nozzles 81.

According to the timing A of cleaning shown in FIG. 13(a), at least during the period in which the rinsing process is performed (ON) in the cleaning processing unit 5a-5d, the guard cleaning nozzles 81 are cleaned. In this case, for example, at the time TR1 at which the rinsing process starts (ON), cleaning of the guard cleaning nozzles 81 starts (ON). Then at the time TR2 at which the rinsing process ends (OFF), the cleaning of the guard cleaning nozzle 81 ends (OFF).

When the timing A of cleaning is set as described above, it is possible to sufficiently prevent adhesion of the first cleaning liquid to the guard cleaning nozzles 81, and generation of precipitates of the first cleaning liquid. As a result, generation of particles from the deposits of the first cleaning liquid is prevented.

According to the timing B of cleaning shown in FIG. 13(b), at least during the period in which the drying process is performed (ON) in the cleaning processing unit 5a-5d, the guard cleaning nozzles 81 are cleaned. In this case, for example, at the time TD1 at which the drying process starts (ON), cleaning of the guard cleaning nozzles 81 starts (ON). Then at the time TD2 at which the drying process ends (OFF), cleaning of the guard cleaning nozzles 81 ends (OFF).

When the timing B of cleaning is set as described above, it is possible to sufficiently prevent adhesion of the first cleaning liquid to the guard cleaning nozzles 81, and generation of precipitates of the first cleaning liquid. As a result, generation of particles from deposits of the first cleaning liquid is prevented.

Besides the above, cleaning of the guard cleaning nozzles 81 by the nozzle cleaning nozzles 181 may be performed, for example, in a period in which none of the chemical solution process, the rinsing process, and the drying process is performed on substrate W. More specifically, it may be performed at the time of carrying in and out of the substrate W to/from the cleaning processing unit 5a-5d, or when a substrate W to be processed next is not carried in yet after the processed substrate W has been carried out.

When cleaning of the guard cleaning nozzles 81 with the second cleaning liquid is performed at a timing different from the timing perform of the chemical solution process on the substrate W as described above, it is preferred to drain the second cleaning liquid through the drain system pipe 130 shown in FIG. 10.

Thus, the second cleaning liquid having different ingredients from those of the chemical solution is no longer reused in the process of substrate W, so that the second cleaning liquid is prevented from being mixed into the chemical solution. As a result, reduction in life of the chemical solution is prevented.

### 2. Second Embodiment

A substrate processing apparatus according to the second embodiment differs in structure from the substrate processing apparatus 100 according to the first embodiment in the following points.

The substrate processing apparatus according to the present embodiment has a structure for removing precipitates of the chemical solution adhering to the recovery liquid guiding part 42 of the splash guard 24, or to the inner wall face 23I of the processing cup 23 in the cleaning processing unit 5a-5d shown in FIG. 2.

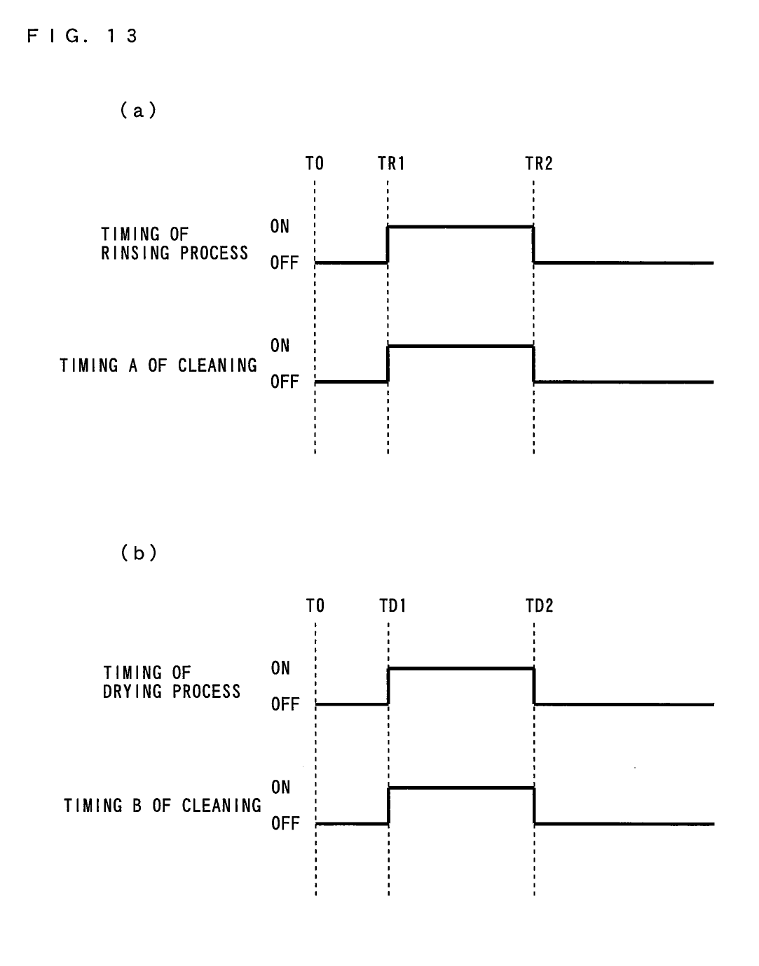

FIG. 14 is a view for explaining the structure of the cleaning processing unit 5a-5d in the substrate processing apparatus according to the second embodiment.

As shown in FIG. 14, in the present embodiment, in place of the guard cleaning nozzles 81 shown in FIG. 2 provided on the upper end of the processing cup 23 in the first embodiment, member cleaning nozzles 91 are attached to the upper end of the partition wall 33. The member cleaning nozzles 91 have generally the same shape as the guard cleaning nozzles 81, however, a plurality of cleaning liquid injection openings are formed in positions different from those for the case of the guard cleaning nozzles 81.

As shown in FIG. 14, the member cleaning nozzles 91 are connected to member cleaning supply pipes 92. The member cleaning nozzles 91 are supplied with the first cleaning liquid from the fluid box 2a-2d via the member cleaning supply pipes 92.

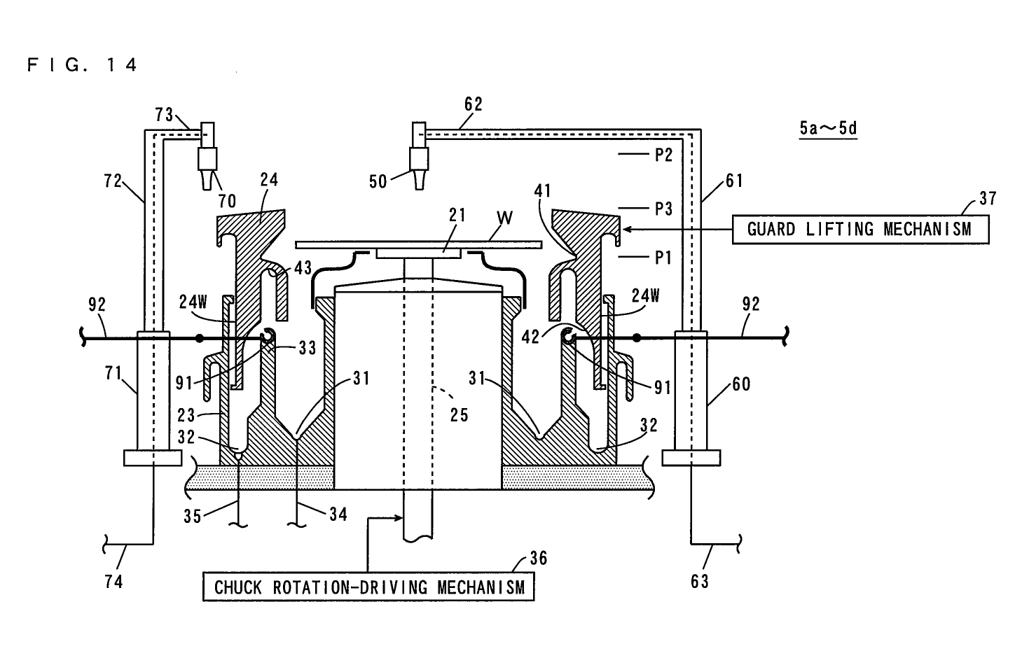

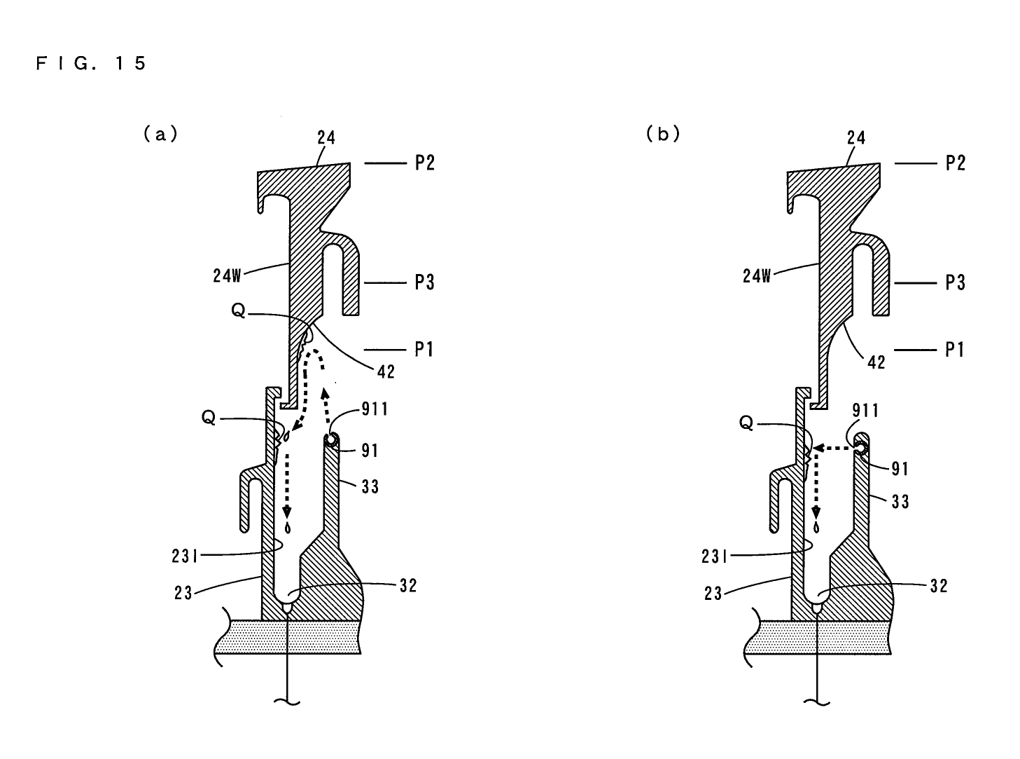

FIG. 15 is a partial enlarged sectional view of the cleaning processing unit 5a-5d shown in FIG. 14.

FIG. 15(a) shows one exemplary structure for cleaning the recovery liquid guiding part 42 of the splash guard 24.

As described above, the member cleaning nozzle 91 is attached to the upper end of the partition wall 33 of the processing cup 23. In the present example, a plurality of cleaning liquid injection openings 911 are formed so as to face the upper position of the recovery liquid guiding part 42 of the splash guard 24 when the splash guard 24 is positioned in the circulation position P2.

In this case, the first cleaning liquid is injected toward the upper position of the recovery liquid guiding part 42 from the plurality of cleaning liquid injection openings 911 of the member cleaning nozzle 91.

Thus, deposits Q on the recovery liquid guiding part 42 of the splash guard 24 are washed out by the first cleaning liquid.

Further, the first cleaning liquid flowing down from the recovery liquid guiding part 42 flows down along the inner wall face 23I of the processing cup 23. Thus, deposits Q on the inner wall face 23I are also washed out by the first cleaning liquid.

As described above, in this example, the member cleaning nozzle 91 provided in the upper end of the partition wall 33 enables the precipitates of the chemical solution adhering to the recovery liquid guiding part 42 of the splash guard 24 and to the inner wall face 23I of the processing cup 23 to be securely removed when the splash guard 24 is positioned in the circulation position P2, namely during the chemical solution process.

FIG. 15(b) shows one exemplary structure for cleaning the inner wall face 23I of the processing cup 23.

As describe above, the member cleaning nozzle 91 is attached to the upper end of the partition wall 33 of the processing cup 23. In the present example, a plurality of cleaning liquid injection openings 911 are formed so as to face the inner wall face 23I of the processing cup 23 when the splash guard 24 is positioned in the circulation position P2.

In this case, the first cleaning liquid is injected toward the inner wall face 23I of the processing cup 23 from the plurality of cleaning liquid injection openings 911 of the member cleaning nozzle 91.

Thus, deposits Q on the inner wall face 23I of the processing cup 23 are washed out by the first cleaning liquid.

As described above, in this example, the member cleaning nozzle 91 provided in the upper end of the partition wall 33 enables the precipitates of the chemical solution adhering to the inner wall face 23I of the processing cup 23 to be securely removed when the splash guard 24 is positioned in the circulation position P2, namely during a chemical solution process.

Preferably, the first cleaning liquid to be injected from the member cleaning nozzle 91 is also mixed with a gas such as air or the inert gas. The cleaning liquid mixed with the gas is injected at large spread angle from the plurality of cleaning liquid injection openings 911. As a result, much higher cleaning efficiency is realized.

Similarly to the first embodiment, also in the present embodiment, nozzle cleaning nozzles for cleaning the member cleaning nozzles 91 may further be provided. In this case, precipitates of the first cleaning liquid adhering to the member cleaning nozzles 91 are removed by the second cleaning liquid supplied from the nozzle cleaning nozzles. Thus, generation of particles from deposits on the member cleaning nozzles 91 is prevented.

In the present embodiment, the guard cleaning nozzles 81 described in the first embodiment and shown in FIG. 2 may further be provided on the upper end of the processing cup 23.

Thus, since the outer wall face 24W of the splash guard 24, as well as the recovery liquid guiding part 42 of the splash guard 24 or the inner wall face 23I of the processing cup 23 is cleaned, generation of particles caused by deposits Q of the chemical solution is prevented more sufficiently. As a result, processing defects of the substrate W are securely prevented.

### 3. Third Embodiment

A substrate processing apparatus according to the third embodiment differs in structure from the substrate processing apparatus 100 according to the first embodiment in the following points.

The substrate processing apparatus according to the present embodiment has structure for removing precipitates of the chemical solution adhering to the vicinity of the lower end of the inner wall face 23I of the processing cup 23 in the cleaning processing unit 5a-5d shown in FIG. 2.

FIG. 16 is a view for explaining the structure of the cleaning processing unit 5a-5d in the substrate processing apparatus according to the third embodiment.

As shown in FIG. 16, in the present embodiment, in place of the guard cleaning nozzles 81 shown in FIG. 2 provided on the upper end of the processing cup 23 in the first embodiment, member cleaning nozzles 93 are attached to the vicinity of the lower end of the partition wall 33. The member cleaning nozzles 93 have generally the same shape as the guard cleaning nozzles 81, however, a plurality of cleaning liquid injection openings are formed in positions different from those for the case of the guard cleaning nozzles 81.

As shown in FIG. 16, the member cleaning nozzles 93 are connected to member cleaning supply pipes 94. The member cleaning nozzles 93 are supplied with the first cleaning liquid from the fluid box 2a-2d via the member cleaning supply pipes 94.

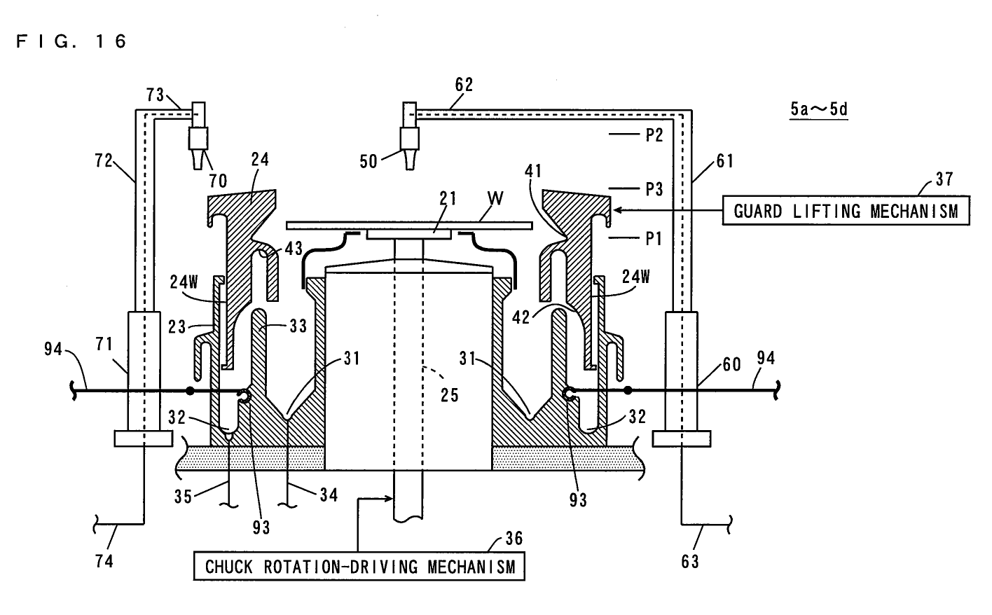

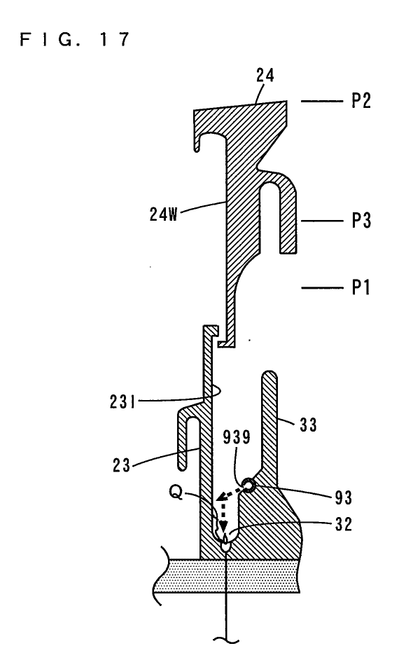

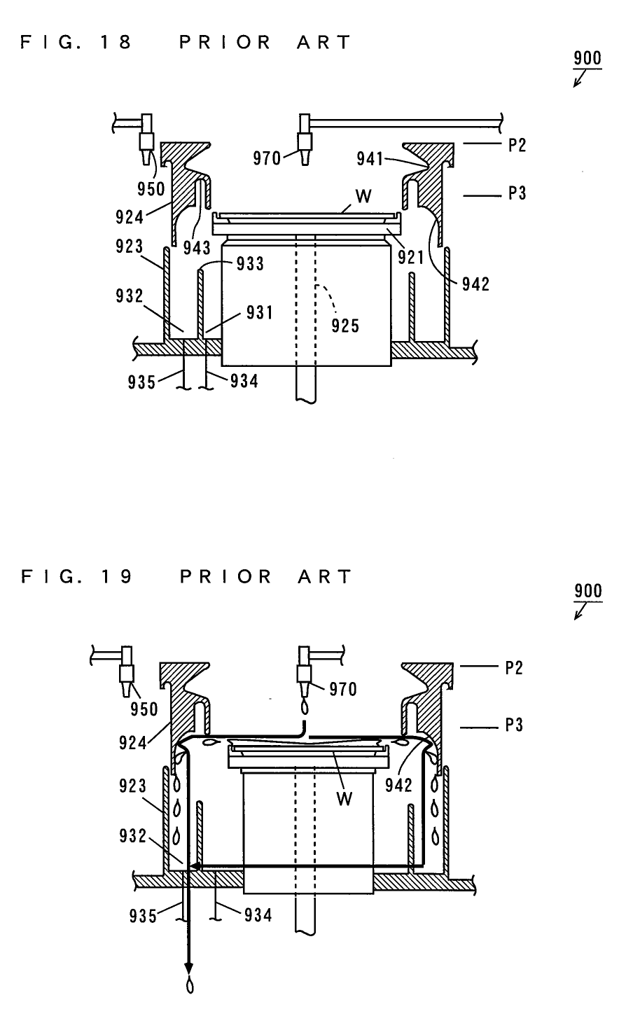

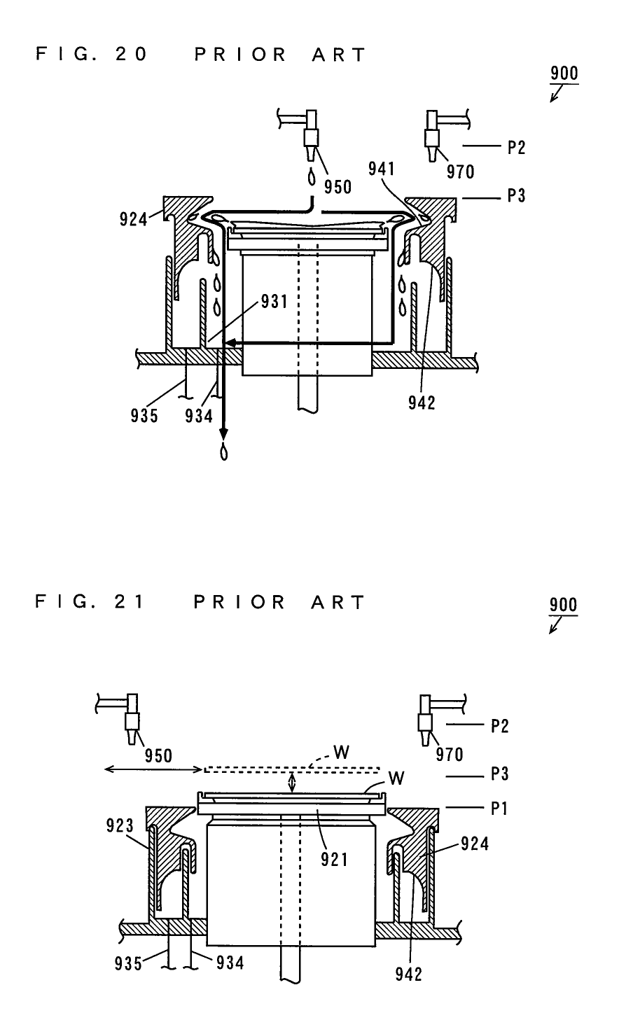

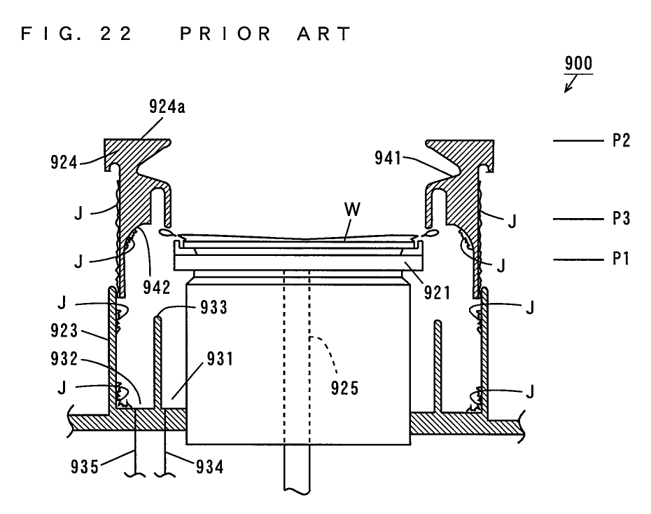

FIG. 17 is a partial enlarged sectional view of the cleaning processing unit 5a-5d shown in FIG. 16.

FIG. 17 shows one exemplary structure for cleaning the vicinity of the lower end of the inner wall face 23I of the processing cup 23.

As describe above, the member cleaning nozzle 93 is attached to the vicinity of the lower end of the partition wall 33 of the processing cup 23. In the present example, a plurality of cleaning liquid injection openings 939 are formed so as to face the vicinity of the lower end of the inner wall face 23I of the processing cup 23.

In this case, the first cleaning liquid is injected toward the vicinity of the lower end of the inner wall face 23I of the processing cup 23 from the plurality of cleaning liquid injection openings 939 of the member cleaning nozzle 93.

Thus, the deposits Q in the vicinity of the lower end of the inner wall face 23I of the processing cup 23 are washed out by the first cleaning liquid.

As described above, in this example, the member cleaning nozzle 93 provided in the vicinity of the lower end of the partition wall 33 enables the precipitates of the chemical solution adhering to the vicinity of the lower end of the inner wall face 23I of the processing cup 23 to be securely removed.

Preferably, the first cleaning liquid to be injected from the member cleaning nozzle 93 is also mixed with a gas such as air or the inert gas. The cleaning liquid mixed with the gas is injected at a large spread angle from the plurality of cleaning liquid injection openings 939. As a result, much higher cleaning efficiency is realized.

Similarly to the first embodiment, also in the present embodiment, nozzle cleaning nozzles for cleaning the member cleaning nozzles 93 may further be provided. In this case, precipitates of the first cleaning liquid adhering to the member cleaning nozzles 93 are removed by the second cleaning liquid supplied from the nozzle cleaning nozzles. Thus, generation of particles from deposits on the member cleaning nozzles 93 is prevented.

In the present embodiment, the guard cleaning nozzles 81 described in the first embodiment and shown in FIG. 2, and the member cleaning nozzles 91 described in the second embodiment and shown in FIG. 14 may further be provided.

In this case, since the recovery liquid guiding part 42 of the splash guard 24, the inner wall face 23I of the processing cup 23 and the outer wall face 24W of the splash guard 24, as well as the vicinity of the lower end of the inner wall face 23I of the processing cup 23 are cleaned, generation of particles caused by deposits Q of the chemical solution is prevented more sufficiently. As a result, processing defects of substrate W is securely prevented.

### 4. Correspondence Between Elements in Claims and Parts in Embodiment

In the first to third embodiments described above, the spin chuck 21 corresponds to a substrate holding device, the chemical solution nozzle 50 corresponds to a chemical solution supplying device, the processing cup 23 and the splash guard 24 correspond to a member, the first cleaning liquid corresponds to a cleaning liquid having the same ingredients as the chemical solution, and the guard cleaning nozzles 81 and the member cleaning nozzles 91, 93 correspond to a cleaning liquid supplying device.

The recovery pipe 35, circulation system pipes 120A, 120B, recovery tank RTA, pump 120P and chemical solution storage tank TA correspond to a recovering device, air or an inert gas such as N₂ gas corresponds to a gas, the controller 4 corresponds to a controller, the deposit detector SN corresponds to a detector, the second cleaning liquid corresponds to a dissolving liquid, and the nozzle cleaning nozzles 181 correspond to a dissolving liquid supplying device.

The plurality of cleaning liquid injection openings 811, 911, 939 correspond to discharge openings, the rinse nozzle 70 corresponds to a rinse liquid supplying device, the chuck rotation-driving mechanism 36 corresponds to a rotation driving device, the supply pipe 63 for chemical solution process and the pump 74P correspond to a circulation system, the processing cup 23 and the splash guard 24 correspond to a guiding member.

The splash guard 24 corresponds to an anti-scattering member, the processing cup 23 corresponds to a receiving member, the inner wall face of the splash guard 24 or the inner wall face 23I of the processing cup 23 corresponds to an inner wall face of the guiding member, the guard opposite parts 81a and corresponding parts of the guard opposite parts 81a of the member cleaning nozzles 91, 93 correspond to a cylindorical member, and BHF corresponds to a solution containing a removing liquid and a salt.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A substrate processing apparatus comprising:
a substrate holding device that holds a substrate;
a chemical solution supplying device that supplies the substrate held by said substrate holding device with a chemical solution;
a member provided at a position where the chemical solution scattering from the substrate held by said substrate holding device adheres;
a cleaning liquid supplying device that cleans said member by supplying said member with a cleaning liquid having the same ingredients as said chemical solution without being in contact with the substrate held by said substrate holding device; and
a recovering device that recovers the chemical solution supplied to the substrate by said chemical solution supplying device and the cleaning liquid supplied to said member by said cleaning liquid supplying device.

2. The substrate processing apparatus according to claim 1, wherein the concentration of the cleaning liquid supplied to said member by said cleaning liquid supplying device is substantially equal to the concentration of the chemical solution supplied to the substrate by said chemical solution supplying device.

3. The substrate processing apparatus according to claim 1, wherein said cleaning liquid supplying device supplies said member with a cleaning liquid in which a gas is mixed.

4. The substrate processing apparatus according to claim 1, further comprising a controller that controls supply of the cleaning liquid to said member,
said controller controlling said cleaning liquid supplying device to supply said member with the cleaning liquid while the chemical solution is supplied to the substrate by said chemical solution supplying device.

5. The substrate processing apparatus according to claim 1, further comprising a controller that controls supply of the cleaning liquid to said member,
said controller controlling said cleaning liquid supplying device to intermittently supply said member with the cleaning liquid.

6. The substrate processing apparatus according to claim 1, further comprising a controller that controls supply of the cleaning liquid to said member, and a detector that provides change in surface condition of a part of said member where the chemical solution scattering from the substrate held by said substrate holding device adheres, as a detection signal to said controller, wherein
said controller controls said cleaning liquid supplying device to supply said member with the cleaning liquid based on said detection signal provided by said detector.

7. The substrate processing apparatus according to claim 1, further comprising a dissolving liquid supplying device that supplies a part of said member and said cleaning liquid supplying device where the cleaning liquid supplied from said cleaning liquid supplying device adheres, with a dissolving liquid having different ingredients from the cleaning liquid supplied to said member by said cleaning liquid supplying device and capable of dissolving said cleaning liquid.

8. The substrate processing apparatus according to claim 7, wherein
said cleaning liquid supplying device has a discharge opening through which the cleaning liquid is discharged, and
said dissolving liquid supplying device supplies said discharge opening of said cleaning liquid supplying device with said dissolving liquid.

9. The substrate processing apparatus according to claim 7, further comprising a rinse liquid supplying device that supplies the substrate held by said substrate holding device with a rinse liquid for washing out said chemical solution remaining on the substrate,
said dissolving liquid supplying device supplying said member and said cleaning liquid supplying device with said dissolving liquid at the time of supplying said rinse liquid.

10. The substrate processing apparatus according to claim 7, further comprising a rotation driving device that rotates said substrate holding device for drying a substrate,
said dissolving liquid supplying device supplying said member and said cleaning liquid supplying device with said dissolving liquid at the time of drying said substrate.

11. The substrate processing apparatus according to claim 1, further comprising a circulation system that returns the chemical solution recovered by said recovering device to said chemical solution supplying device,
said member including a guiding member that leads the chemical solution supplied to the substrate by said chemical solution supplying device and the cleaning liquid supplied to said member by said e cleaning liquid supplying device, to said recovering device.

12. The substrate processing apparatus according to claim 11, wherein
said guiding member includes an anti-scattering member that is provided so as to surround said substrate holding device, and receives the chemical solution scattering from the substrate held by said substrate holding device.

13. The substrate processing apparatus according to claim 12, wherein said guiding member further includes a receiving member that is provided below said anti-scattering member and receives the chemical solution flowing down from said anti-scattering member and leads the chemical solution to said recovering device.

14. The substrate processing apparatus according to claim 11, wherein said cleaning liquid supplying device includes a cylindorical member provided along an inner wall face of said guiding member, and having a plurality of cleaning liquid supply openings opposite to the inner wall face of said guiding member.

15. The substrate processing apparatus according to claim 1, wherein said chemical solution is a removing liquid that removes contaminants on the surface of the substrate.

16. The substrate processing apparatus according to claim 1, wherein said chemical solution is a solution containing salt.

17. A substrate processing method comprising the steps of:
processing a substrate by supplying the substrate held by a substrate holding device with a chemical solution;
cleaning a member that is in a position where the chemical solution scattering from the substrate adheres, by supplying said member with a cleaning liquid having the same ingredients as the chemical solution without being in contact with the substrate held by said substrate holding device; and
recovering the chemical solution supplied to the substrate and the cleaning liquid supplied to said member.

18. The substrate processing method according to claim 17, wherein said step of cleaning the member includes the step of supplying said member with the cleaning liquid while the chemical solution is supplied to the substrate.

19. The substrate processing method according to claim 17, wherein said step of cleaning the member includes the step of intermittently supplying said member with the cleaning liquid.

20. The substrate processing method according to claim 17, wherein said step of cleaning the member includes the steps of
detecting change in surface condition of a part of said member where the chemical solution scattering from the substrate adheres, and
controlling supply of the cleaning liquid to said member based on said detection of change in surface condition.
